(19) United States
(12) Patent Application Publication
(10) Pub. No.: US 2018/0083914 A1
(43) Pub. Date: Mar. 22, 2018

(54) COMMUNICATION APPARATUS, SERVER APPARATUS, COMMUNICATION SYSTEM, COMPUTER PROGRAM PRODUCT, AND COMMUNICATION METHOD

(71) Applicant: Kabushiki Kaisha Toshiba, Minato-ku (JP)

(72) Inventor: Takahiro YAMAURA, Kawasaki (JP)

(73) Assignee: Kabushiki Kaisha Toshiba, Minato-ku (JP)

(21) Appl. No.: 15/425,493

(22) Filed: Feb. 6, 2017

(30) Foreign Application Priority Data
Sep. 20, 2016 (JP) 2016-183147

(51) Int. Cl. H04L 12/58; H04L 29/08; H04W 4/02; H04W 68/00; H04W 4/04

(52) U.S. Cl. CPC H04L 51/38; H04L 67/12; H04L 51/20; H04W 68/005; H04W 4/046; H04W 4/027

(57) ABSTRACT

According to an embodiment, a communication apparatus includes a communication unit and an output unit. The communication unit is configured to receive an unauthorized communication message. The output unit is configured to output a notification message based on the unauthorized communication message. The notification message includes unauthorized communication identification information for identifying the unauthorized communication message and reception position information indicating a position of the communication apparatus when the unauthorized communication message is received. The unauthorized communication identification information includes entire frame information about the unauthorized communication message.

### CROSS-REFERENCE TO RELATED APPLICATIONS

This application is based upon and claims the benefit of priority from Japanese Patent Application No. 2016-183147, filed on Sep. 20, 2016; the entire contents of which are incorporated herein by reference.

### FIELD

Embodiments described herein relate generally to a communication apparatus, a server apparatus, a communication system, a computer program product, and a communication method.

### BACKGROUND

Methods for identifying a source of transmission of a wirelessly transmitted communication message have been known.

For example, it is disclosed that a base unit receives reception times of interfering waves and received signal strength indicators (RSSIs) of the interfering waves from terminals and identifies the position between terminals at which the highest received signal strength indicators are observed as that of the signal generation source of the interfering waves. An apparatus collects wireless signals from a plurality of respective apparatuses, the wireless signals including media access control (MAC) addresses of the respective access points. Patent Literature 2 discloses a system in which an apparatus estimates the position of the own apparatus by using the MAC addresses, arrival times of the wireless signals, and the received signal strength indicators.

According to the conventional techniques, the source of transmission of a communication message has been unable to be identified if communication is performed without establishing a basic service set (BSS). In an ad hoc mode in which apparatuses communicate directly without the intervention of an access point, transmission source MAC addresses may be unfixed for the sake of securing anonymity. For such reasons, the source of transmission of a communication message has conventionally been difficult to identify. According to the conventional techniques, an entity of unauthorized communication has therefore not always been identifiable.

### BRIEF DESCRIPTION OF THE DRAWINGS

FIG. 1 is a schematic diagram of a communication system;

FIG. 2 is a hardware configuration diagram of a communication apparatus;

FIG. 3 is a hardware configuration diagram of a server apparatus;

FIG. 4 is a functional block diagram of the communication apparatus;

FIG. 5 is a schematic diagram of surrounding situation information;

FIG. 6 is a schematic diagram showing a data configuration of a communication message;

FIG. 7 is a schematic diagram showing a data configuration of a notification message;

FIG. 8 is a functional block diagram of the server apparatus;

FIG. 9A is a conceptual diagram of position identification of an entity;

FIG. 9B is an explanatory diagram of a method for excluding exclusion targeted messages;

FIG. 10 is a schematic diagram showing a data configuration of an identification result;

FIG. 11 is a flow chart showing surrounding situation information generation processing;

FIG. 12 is a flow chart showing communication message reception processing;

FIG. 13 is a flow chart showing unauthorized communication message determination processing;

FIG. 14 is a flow chart showing notification message reception processing;

FIG. 15 is a schematic diagram showing a data configuration of a hash table;

FIG. 16 is a flow chart showing entity identification processing;

FIG. 17 is a functional block diagram of a communication apparatus;

FIG. 18 is a schematic diagram showing a data configuration of an identification result message; and

FIG. 19 is a functional block diagram of a server apparatus.

### DETAILED DESCRIPTION

According to an embodiment, a communication apparatus includes a communication unit and an output unit. The communication unit is configured to receive an unauthorized communication message. The output unit is configured to output a notification message based on the unauthorized communication message. The notification message includes unauthorized communication identification information for identifying the unauthorized communication message and reception position information indicating a position of the communication apparatus when the unauthorized communication message is received. The unauthorized communication identification information includes entire frame information about the unauthorized communication message.

A communication apparatus, a server apparatus, a communication system, a communication program, and a communication method will be described in detail below with reference to the accompanying drawings.

### First Embodiment

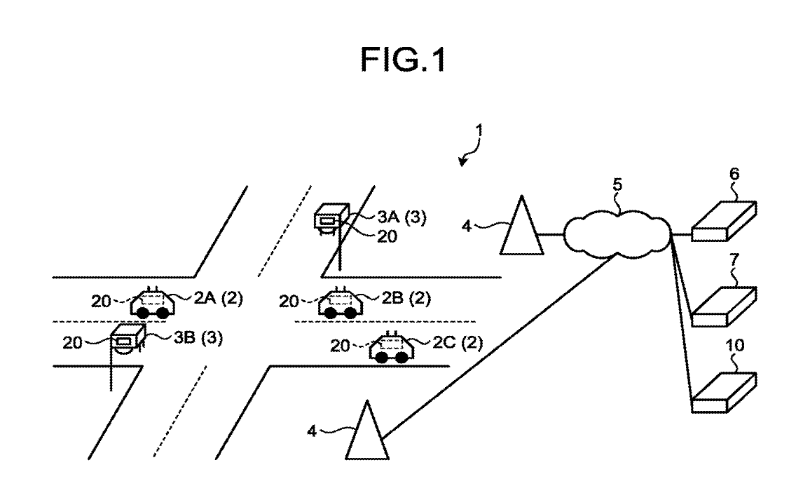

FIG. 1 is a schematic diagram showing an example of a communication system 1 according to the present embodiment.

The communication system 1 includes a server apparatus 10 and a plurality of communication apparatuses 20. In the present embodiment, the communication system 1 includes the server apparatus 10, the plurality of communication apparatuses 20, a map information management apparatus 6, and an authentication apparatus 7.

The communication apparatuses 20 each transmit and receive communication messages to/from the other communication apparatuses 20. Details of the communication messages will be described later. In the present embodiment, the communication apparatuses 20 are mounted on mobile units such as vehicles 2 (vehicles 2A to 2C) and non-mobile units such as roadside units 3 (roadside units 3A and 3B).

Mobile units are movable objects. Examples of the mobile units include a vehicle, a hand cart, a flying object (manned aircraft or unmanned aircraft (such as drone)), and a robot. A mobile unit may be one that moves with the movement of a movable object. For example, a mobile unit may be a portable terminal or an object that is towed to move. In the present embodiment, the mobile units are described to be vehicles 2 as an example. Examples of the vehicles 2 include a two-wheeled vehicle, a three-wheeled vehicle, and a four-wheeled vehicle. In the present embodiment, the vehicles 2 are described to be four-wheeled vehicles as an example.

Non-mobile units are objects fixed to the ground. Examples of the non-mobile units include infrastructural units such as a traffic signal, a traffic sign, and a roadside unit (may be referred to as a roadside sensor). In the present embodiment, the non-mobile units are described to be roadside units 3 as an example.

In other words, in the present embodiment, the communication apparatuses 20 are mounted on the roadside units 3 and the vehicles 2. The communication apparatuses 20 may be mounted on objects other than the roadside units 3 and the vehicles 2.

The communication apparatuses 20 perform direct wireless communication with each other without the intervention of a communication infrastructure. For example, the communication apparatuses 20 communicate with each other by vehicle-to-everything (V2X) communication. V2X communications include IEEE 802.11p-based communications between vehicles (V2V), communications between a vehicle and a communication apparatus (V2I), communications between a vehicle and a pedestrian (V2P), and communications between a vehicle and a home (V2H). In V2X communication, wildcard basic service set identification (BSSID) is used to perform direct wireless communication without establishing a BSS.

V2X communication may be referred to as car-to-x (C2X) communication.

The communication apparatuses 20 can communicate with each of the map information management apparatus 6, the authentication apparatus 7, and the server apparatus 10 via mobile communication base stations 4 and a network 5. The network 5 is a known communication line. The network 5 may be a wired communication network or a wireless communication network. Examples of the network 5 include a local area network (LAN) and the Internet.

The mobile communication base stations 4 are base stations which interconnect the communication apparatuses 20 with the map information management apparatus 6, the authentication apparatus 7, and the server apparatus 10 via the network 5. The mobile communication base stations 4 interconnect the communication apparatuses 20 with the map information management apparatus 6, the authentication apparatus 7, and the server apparatus 10 via the network 5. In other words, the communication apparatuses 20 can communicate with the map information management apparatus 6, the authentication apparatus 7, and the server apparatus 10 via the mobile communication base stations 4 and the network 5. The map information management apparatus 6, the authentication apparatus 7, and the server apparatus 10 can communicate via the network 5.

The map information management apparatus 6 manages map information. The map information management apparatus 6 transmits map information about a predetermined range around the current position of each of the communication apparatuses 20 to the respective corresponding communication apparatuses 20. In the present embodiment, if the map information management apparatus 6 receives a map acquisition request from a communication apparatus 20, the map information management apparatus 6 transmits map information about a predetermined range around the current position of the communication apparatus 20 to the communication apparatus 20.

The authentication apparatus 7 manages authentication information. The authentication information is information for authenticating communication messages communicated between the communication apparatuses 20. For example, the authentication information includes an encryption key (such as a public key) used to encrypt a communication message, and an invalidation list. The invalidation list is a list of apparatus IDs of communication apparatuses 20 that are invalidated (unreliable) in the public key infrastructure. The apparatus IDs are identification information about the communication apparatuses 20.

If the authentication apparatus 7 receives an authentication acquisition request from a communication apparatus 20, the authentication apparatus 7 transmits the authentication information to the communication apparatus 20.

The server apparatus 10 communicates with each of the plurality of communication apparatuses 20 via the network 5 and the mobile communication base stations 4. For example, the server apparatus 10 is installed in a data center for managing data. In the present embodiment, the server apparatus 10 identifies an entity that transmits an unauthorized communication message, on the basis of the unauthorized message received by the communication apparatuses 20 (to be described in detail later). Details of communication messages and unauthorized communication messages will be described later.

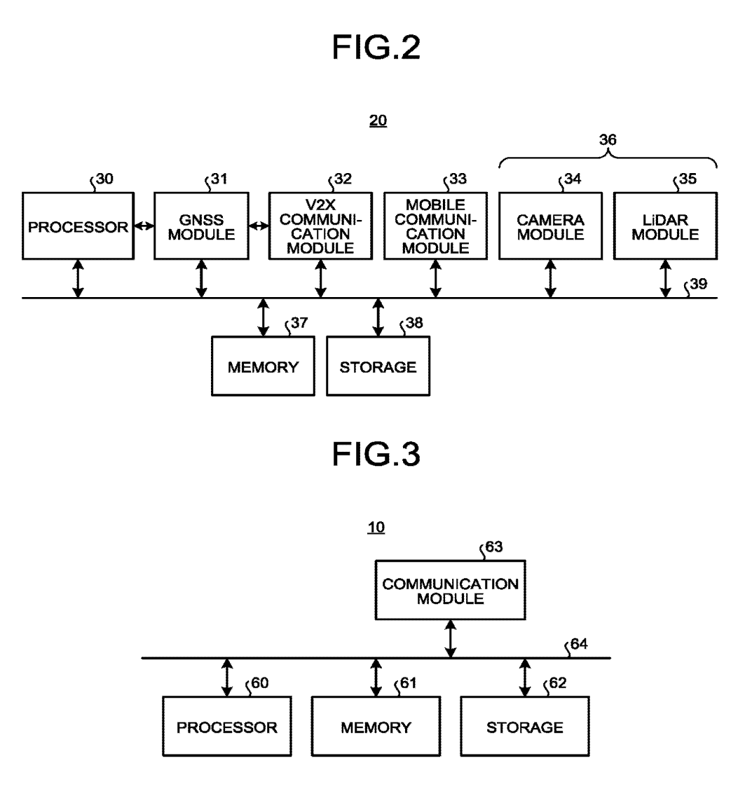

Next, an example of a hardware configuration of the communication apparatuses 20 will be described. FIG. 2 is an example of a hardware configuration diagram of the communication apparatuses 20.

A communication apparatus 20 includes a processor 30, a global navigation satellite system (GNSS) module 31, a V2X communication module 32, a mobile communication module 33, external sensors 36, a memory 37, and a storage 38. The processor 30, the GNSS module 31, the V2X communication module 32, the mobile communication module 33, the external sensors 36, the memory 37, and the storage 38 are connected to each other via a bus 39.

The processor 30 controls the communication apparatus 20. The term “processor” used in the present and subsequent embodiments refers to, for example, the circuit of a CPU, a graphical processing unit (GPU), an application specific integrated circuit (ASIC), a programmable logic device (such as a simple programmable logic device (SPLD)), a complex programmable logic device (CPLD), or a field programmable gate array (FPGA).

The GNSS module 31 measures position information about the current position of the communication apparatus 20 and the current time. The V2X communication module 32 is a communication module for performing direct wireless communication with the other communication apparatuses 20. In the present embodiment, the V2X communication module 32 is a communication module for performing V2X communication with the other communication apparatuses 20 mounted on the other vehicles 2 and roadside units 3.

The processor 30 and the V2X communication module 32 are connected to the GNSS module 31. The processor 30 and the V2X communication module 32 are configured to be able to synchronize with the correct time by using a pulse-per-second (PPS) signal output from the GNSS module 31.

The mobile communication module 33 is a communication module by which the communication apparatus 20 communicates with at least one of the map information management apparatus 6, the authentication apparatus 7, and the server apparatus 10 via the mobile communication base stations 4 and the network 5. The mobile communication module 33 is a communication module using a known communication standard or standards. Examples of the known communication standards include 3G (3rd generation), 4G (4th generation), LTE (Long Term Evolution), and 5G (5th generation).

The external sensors 36 are sensors for observing surrounding information about the communication apparatus 20 (i.e., the vehicle 2 or roadside unit 3 on which the communication apparatus 20 is mounted). Examples of the external sensors 36 include a camera module 34 and a distance sensor.

The camera module 34 obtains captured image data around the communication apparatus 20 (hereinafter, referred to simply as a surrounding image) by imaging.

The distance sensor measures distances to objects around the communication apparatus 20 by ranging, and obtains distance information. Examples of the distance information include a depth map which defines a distance pixel by pixel. Examples of the distance sensor include a millimeter wave radar and a laser sensor. Among examples of the laser sensor is one using a laser imaging detection and ranging (LiDAR) system.

In the present embodiment, the communication apparatus 20 is described to include the camera module 34 and a LiDAR module 35 as the external sensors 36, for example.

The camera module 34 may be configured as a single module capable of omnidirectional imaging. The camera module 34 may include a plurality of modules having different imaging ranges at least in part. Similarly, the LiDAR module 35 may be configured as a single module capable of omnidirectional ranging. The LiDAR module 35 may include a plurality of modules having different ranging coverages at least in part.

The memory 37 stores a program and the like for performing processing of the communication apparatus 20 to be described later. For example, the memory 37 includes a ROM and a RAM. The program is stored in the ROM. The storage 38 stores various types of data. Examples of the storage 38 include a hard disk drive and a flash memory.

The processor 30, the memory 37, and the storage 38 may be configured as a single circuit or a single functional unit each. The processor 30, the memory 37, and the storage 38 may include a plurality of circuits or a plurality of functional units each.

The communication apparatus 20 may implement the functions of the mobile communication module 33 by using the V2X communication module 32. In such a case, the communication apparatus 20 may be configured to include no mobile communication module 33. If the communication apparatus 20 is mounted on a roadside unit 3, the communication apparatus 20 may be configured to be connectable to at least one of the map information management apparatus 6, the authentication apparatus 7, and the server apparatus 10 via a communication module that can connect to a fixed communication network using a dedicated line or the like, instead of the mobile communication module 33.

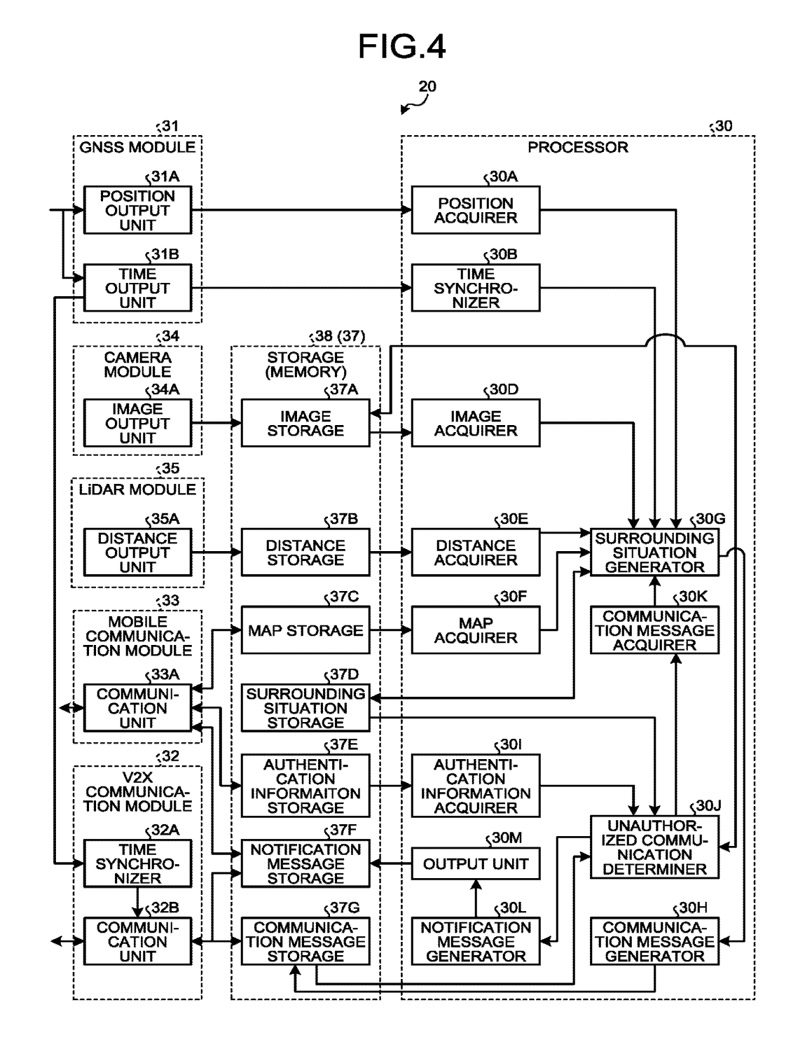

Next, an example of a hardware configuration of the server apparatus 10 will be described. FIG. 3 is an example of a hardware block diagram of the server apparatus 10.

The server apparatus 10 includes a processor 60, a memory 61, a storage 62, and a communication module 63. The processor 60, the memory 61, the storage 62, and the communication module 63 are connected to each other via a bus 64.

The processor 60 controls the server apparatus 10. The communication module 63 is a communication module by which the server apparatus 10 communicates with each of the map information management apparatus 6, the authentication apparatus 7, and the communication apparatuses 20 via the network 5.

The memory 61 stores a program and the like for performing processing of the server apparatus 10 to be described later. For example, the memory 61 includes a ROM and a RAM. The program is stored in the ROM. The storage 62 stores various types of data. Examples of the storage 62 include a hard disk drive and a flash memory.

The processor 60, the memory 61, and the storage 62 may be configured as a single circuit or a single functional unit each. The processor 60, the memory 61, and the storage 62 may include a plurality of circuits or a plurality of functional units each.

Next, the functions of the communication apparatus 20 will be described.

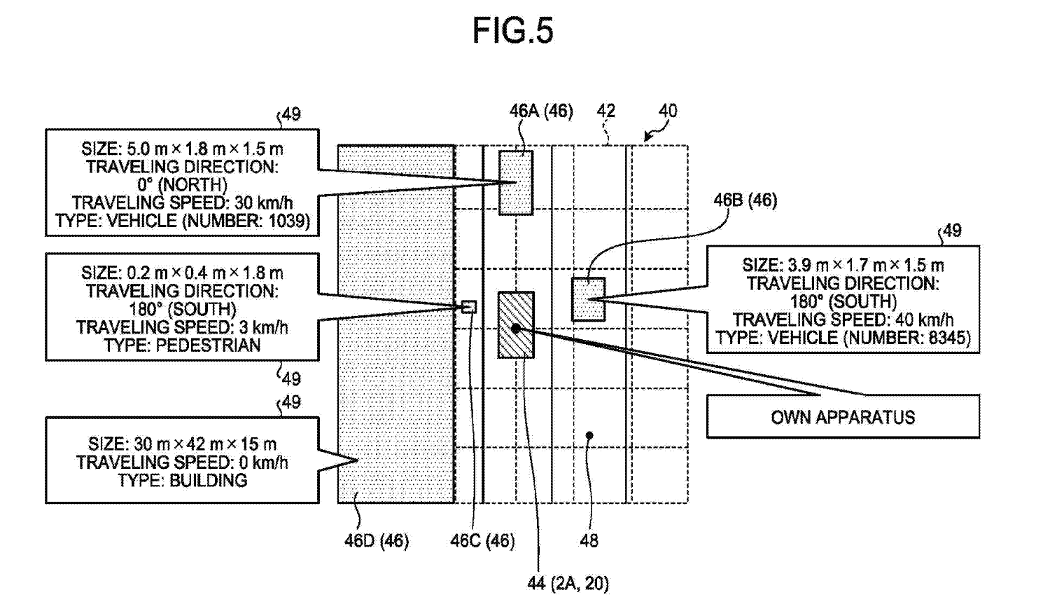

FIG. 4 is an example of a functional block diagram of the communication apparatus 20.

The GNSS module 31 includes a position output unit 31A and a time output unit 31B. The position output unit 31A measures the position information about the communication apparatus 20 on the basis of a reception signal received from a positioning satellite. The position output unit 31A outputs the measured position information to the processor 30. For example, the position information is expressed by a latitude, a longitude, and an altitude.

The time output unit 31B measures the current time on the basis of the reception signal received from the positioning satellite. The time output unit 31B outputs the measured current time to the processor 30 and the V2X communication module 32.

The camera module 34 includes an image output unit 34A. The image output unit 34A stores a captured surrounding image of the surrounding area of the vehicle 2 or roadside unit 3 on which the communication apparatus 20 is mounted, into an image storage 37A of the storage 38 in association with imaging time of the surrounding image. For example, the imaging time may be relative time retained in the camera module 34. The imaging time may be time obtained by performing synchronization with the processor 30 in advance. The image output unit 34A may store the surrounding image into the storage 38 and output the surrounding image to the processor 30 via the memory 37.

The LiDAR module 35 includes a distance output unit 35A. The distance output unit 35A stores distance information about the surrounding area of the vehicle 2 or roadside unit 3 on which the communication apparatus 20 is mounted, into a distance storage 37B of the memory 37 in association with ranging time of the distance information. For example, the ranging time may be relative time retained in the LiDAR module 35. The ranging time may be time obtained by performing synchronization with the processor 30 in advance. The distance output unit 35A may store the distance information into the storage 38 and output the distance information to the processor 30 via the memory 37.

The mobile communication module 33 includes a communication unit 33A. The communication unit 33A communicates with the map information management apparatus 6, the authentication apparatus 7, and the server apparatus 10.

In the present embodiment, the communication unit 33A receives map information from the map information management apparatus 6. More specifically, the communication unit 33A transmits a map acquisition request to the map information management apparatus 6 under the control of the processor 30. The communication unit 33A here transmits a map acquisition request including the position information measured by the GNSS module 31 to the map information management apparatus 6. Receiving the map acquisition request, the map information management apparatus 6 transmits the map information about a predetermined range around the position indicated by the position information to the communication apparatus 20 that is the source of transmission of the map acquisition request. The communication unit 33A of the communication apparatus 20 thus receives the map information from the map information management apparatus 6.

The communication unit 33A stores the received map information into a map storage 37C of the storage 38.

The communication unit 33A receives the authentication information from the authentication apparatus 7. More specifically, the communication unit 33A transmits an authentication acquisition request to the authentication apparatus 7 under the control of the processor 30. Receiving the authentication acquisition request, the authentication apparatus 7 transmits the authentication information to the communication apparatus 20 that is the source of transmission of the authentication acquisition request. The communication unit 33A of the communication apparatus 20 thus receives the authentication information from the authentication apparatus 7.

The communication unit 33A stores the received authentication information into an authentication information storage 37E of the storage 38.

The V2X communication module 32 includes a time synchronizer 32A and a communication unit 32B.

The time synchronizer 32A synchronizes the communication unit 32B with the current time output from the time output unit 31B.

The communication unit 32B is an example of the communication unit of the communication apparatus according to the present embodiment.

The communication unit 32B receives communication messages from the other communication apparatuses 20. The communication unit 32B transmits communication messages to the other communication apparatuses 20 under the control of the processor 30.

If the communication unit 32B receives a communication message from another communication apparatus 20, the communication unit 32B stores the communication message into a communication message storage 37G. In the present embodiment, the communication unit 32B stores the communication message received from another communication apparatus 20 into the communication message storage 37G so that the communication message is associated with the reception time of the communication message and the received signal strength indicator (RSSI) of the communication message.

The storage 38 stores various types of data. In the present embodiment, the storage 38 includes the image storage 37A, the distance storage 37B, the map storage 37C, a surrounding situation storage 37D, the authentication information storage 37E, a notification message storage 37F, and the communication message storage 37G.

At least one of the image storage 37A, the distance storage 37B, the map storage 37C, the surrounding situation storage 37D, the authentication information storage 37E, the notification message storage 37F, and the communication message storage 37G may be arranged in the memory 37. At least one of the image storage 37A, the distance storage 37B, the map storage 37C, the surrounding situation storage 37D, the authentication information storage 37E, the notification message storage 37F, and the communication message storage 37G may be a database, a file, a memory area (for example, a memory area reserved by an application or an OS), or any one of distinct storage media.

The image storage 37A stores the surrounding image and the imaging time in association with each other. The distance storage 37B stores the distance information and the ranging time in association with each other. The map storage 37C stores the map information. The surrounding situation storage 37D stores surrounding situation information. Details of the surrounding situation information will be described later. The authentication information storage 37E stores the authentication information. The notification message storage 37F stores notification messages. Details of the notification messages will be described later. The communication message storage 37G stores communication messages. As described above, the communication message storage 37G stores a communication message received from another communication apparatus 20, the reception time of the communication message, and the received signal strength indicator of the communication message in association with each other.

The processor 30 includes a position acquirer 30A, a time synchronizer 30B, an image acquirer 30D, a distance acquirer 30E, a map acquirer 30F, a surrounding situation generator 30G, a communication message generator 30H, an authentication information acquirer 30I, an unauthorized communication determiner 30J, a communication message acquirer 30K, a notification message generator 30L, and an output unit 30M.

Part or all of the position acquirer 30A, the time synchronizer 30B, the image acquirer 30D, the distance acquirer 30E, the map acquirer 30F, the surrounding situation generator 30G, the communication message generator 30H, the authentication information acquirer 30I, the unauthorized communication determiner 30J, the communication message acquirer 30K, the notification message generator 30L, and the output unit 30M may be implemented by causing a CPU or other processor to execute a program or programs, i.e., by software. Part or all of the units 30A to 30M may be implemented by hardware such as an integrated circuit (IC). The units 30A to 30M may be implemented by using both software and hardware.

The time synchronizer 30B accepts the current time from the time output unit 31B, and outputs the current time to the surrounding situation generator 30G.

The surrounding situation generator 30G instructs the position acquirer 30A, the image acquirer 30D, the distance acquirer 30E, and the map acquirer 30F to obtain respective pieces of information at specified time.

The position acquirer 30A obtains the position information from the position output unit 31A. The position acquirer 30A outputs the obtained position information to the surrounding situation generator 30G. More specifically, the position acquirer 30A outputs the position information about the communication apparatus 20 corresponding to the time specified by the surrounding situation generator 30G to the surrounding situation generator 30G.

The image acquirer 30D obtains the surrounding image from the image output unit 34A. In the present embodiment, the image acquirer 30D reads a surrounding image corresponding to the same imaging time as the time specified by the surrounding situation generator 30G from the image storage 37A. The image acquirer 30D obtains a surrounding image that is the closest to the specified time. The image acquirer 30D outputs the read surrounding image to the surrounding situation generator 30G.

The distance acquirer 30E obtains the distance information from the distance output unit 35A. In the present embodiment, the distance acquirer 30E reads distance information corresponding to the same ranging time as the time specified by the surrounding situation generator 30G from the distance storage 37B. The distance acquirer 30E obtains distance information that is the closest to the specified time. The distance acquirer 30E outputs the read distance information to the surrounding situation generator 30G.

The map acquirer 30F obtains the map information from the map information management apparatus 6 via the communication unit 33A. In the present embodiment, the map acquirer 30F outputs map information obtained from the map information management apparatus 6, corresponding to the time specified by the surrounding situation generator 30G, to the surrounding situation generator 30G. Since the map information is updated at long intervals, the last updated map information stored in the map storage 37C is selected.

Consequently, the position information about the communication apparatus 20, the surrounding image of the communication apparatus 20, the distance information about the communication apparatus 20, and the map information that correspond to the specified time are output to the surrounding situation generator 30G.

The map acquirer 30F may read map information including the current position of the communication apparatus 20 from the surrounding situation storage 37D, and output the read map information to the surrounding situation generator 30G. If the map information including the current position of the communication apparatus 20 is not stored in the map storage 37C, the map acquirer 30F may obtain the map information including the current position from the map information management apparatus 6 via the communication unit 33A, and store the obtained map information into the surrounding situation storage 37D. The map acquirer 30F may estimate a position to which the communication apparatus 20 comes a predetermined time later from the current position of the communication apparatus 20, and read and obtain the map information about around the estimated position from the map information management apparatus 6 in advance. If the communication unit 32B can communicate with the map information management apparatus 6, the map acquirer 30F may obtain the map information from the map information management apparatus 6 via the communication unit 32B instead of the communication unit 33A.

The surrounding situation generator 30G generates surrounding situation information which represents a situation around the vehicle 2 or roadside unit 3 on which the communication apparatus 20 is mounted. The surrounding situation generator 30G generates the surrounding situation information on the basis of the position information, the surrounding image, the distance information, and the map information corresponding to the same time (current time). If there is already generated surrounding situation information, the surrounding situation generator 30G updates the generated surrounding situation information on the basis of the newly accepted position information, surrounding image, distance information, and map information. In the following description, to “generate” surrounding situation information refers to both the case of newly generating the surrounding situation information and the case of updating the surrounding situation information.

For example, the surrounding situation generator 30G repeatedly generates (i.e., updates) the surrounding situation information so that the generated surrounding situation information represents the surrounding situation in real time. The surrounding situation generator 30G stores the generated surrounding situation information into the surrounding situation storage 37D in association with the generation time when the surrounding situation information is generated. The surrounding situation information representing the surrounding situation in real time is thus stored in the surrounding situation storage 37D.

For example, the surrounding situation generator 30G obtains the current time, the position information, the surrounding image, the distance information, and the map information from the position acquirer 30A, the time synchronizer 30B, the image acquirer 30D, the distance acquirer 30E, and the map acquirer 30F at predetermined intervals. Each time such pieces of information are obtained, the surrounding situation generator 30G generates the surrounding situation information. The surrounding situation generator 30G may generate the surrounding situation information if at least some of the position acquirer 30A, the time synchronizer 30B, the image acquirer 30D, the distance acquirer 30E, and the map acquirer 30F obtain information that is different at least in part from the previously-obtained current time, position information, surrounding image, distance information, and map information.

The surrounding situation information is information representing the situation around the communication apparatus 20. More specifically, the surrounding situation information is information representing the situation around the vehicle 2 or roadside unit 3 on which the communication apparatus 20 is mounted. In other words, the surrounding situation information is information from which other objects lying around the communication apparatus 20 can be each identified. The other objects refer to objects other than the vehicle 2 or roadside unit 3 on which the communication apparatus 20 is mounted. The other objects may include both mobile units and non-mobile units.

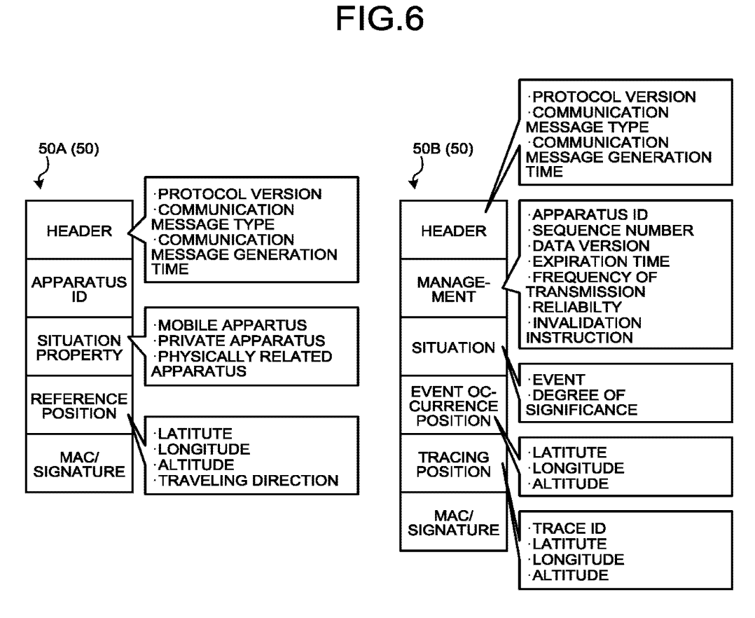

FIG. 5 is a schematic diagram showing an example of surrounding situation information 40. FIG. 5 shows an example of the surrounding situation information 40 that is generated by the communication apparatus 20 mounted on the vehicle 2A (own apparatus 44). The own apparatus 44 refers to the communication apparatus 20 itself which performs the processing.

The surrounding situation information 40 includes at least any one of a surrounding image 42 and distance information, and object recognition information 49 which represents a recognition result of objects 46 included in the surrounding image 42. The object recognition information 49 may be any information from which each object 46 can be identified. For example, the object recognition information 49 includes at least one of the following: a position of an object 46, a size of the object 46, a traveling direction of the object 46, a traveling speed of the object 46, and a type of the object 46.

The position of the object 46 may be an actual position (latitude, longitude, and altitude) in the real space, or a relative position with respect to the communication apparatus 20 that is the own apparatus 44. In the present embodiment, the position of the object 46 is described to be an actual position in the real space.

The size of the object 46 may be an actual size in the real space, or a relative size with respect to a reference object (for example, the vehicle 2A which is the own apparatus 44). In the present embodiment, the side of the object 46 is described to be an actual size in the real space.

The traveling direction and the traveling speed of the object 46 may be derived from a plurality of surrounding images and/or a plurality of pieces of distance information successively obtained in a time series. Values included in a communication message to be described later may be used.

The type of the object 46 is information representing each of a plurality of groups into which objects 46 are classified according to predetermined rules. Examples of the types of objects 46 include a vehicle, a building, and a pedestrian. The types of objects 46 may be information representing groups into which the objects 46 are subdivided according to detailed rules. For example, the types of objects 46 may include a vehicle number, vehicle color, gender, and age.

The surrounding situation generator 30G identifies the objects 46 around the communication apparatus 20 (own apparatus 44) by using known image processing techniques and the like. For example, the surrounding situation generator 30G identifies a position corresponding to the position information obtained from the position acquirer 30A on the surrounding image 42 accepted from the image acquirer 30D. The surrounding situation generator 30G thereby identifies the position equivalent to the current position of the own apparatus 44 (communication apparatus 20) in the surrounding image 42.

The surrounding situation generator 30G performs an image analysis on the surrounding image 42, and analyzes the map information accepted from the map acquirer 30F and the distance information accepted from the distance acquirer 30E. By such analyses, the surrounding situation generator 30G identifies object recognition information 49 (position, size, traveling direction, traveling speed, and type) about other objects 46 included in the surrounding image 42 (in the example shown in FIG. 5, objects 46A to 46D). The surrounding situation generator 30G reflects the object recognition information 49 about the identified objects 46 on positions in the surrounding image 42 corresponding to the positions of the respective objects 46 in the real space.

In other words, the surrounding situation generator 30G recognizes the objects 46 from the surrounding image 42 and the distance information, and maps the recognized objects 46 onto the map information to generate the surrounding situation information 40. After the mapping to the map information, the surrounding situation generator 30G may correct the position information about the communication apparatus 20.

In such a manner, the surrounding situation generator 30G generates the surrounding situation information 40. The surrounding situation generator 30G stores the generated surrounding situation information into the surrounding situation storage 37D.

If the surrounding situation generator 30G obtains a normal communication message from the communication message acquirer 30K to be described later, the surrounding situation generator 30G reflects the normal communication message on the surrounding situation information 40 (see point 48 in FIG. 5) (details will be described later). If the surrounding situation generator 30G detects an event to be notified to the other communication apparatuses 20 as a result of generation of the surrounding situation information 40, the surrounding situation generator 30G outputs a generation request for a communication message to the communication message generator 30H (details will be described later).

Next, the unauthorized communication determiner 30J will be described. If the communication unit 32B receives a new communication message from another communication apparatus 20, the unauthorized communication determiner 30J determines whether the received communication message is an unauthorized communication message.

Now, communication messages will be described in detail.

A communication message is a message communicated between communication apparatuses 20. The message may be any of the following: a segment, a datagram, a packet, and a frame. In the present embodiment, a series of pieces of data in the data link layer will be referred to as a frame.

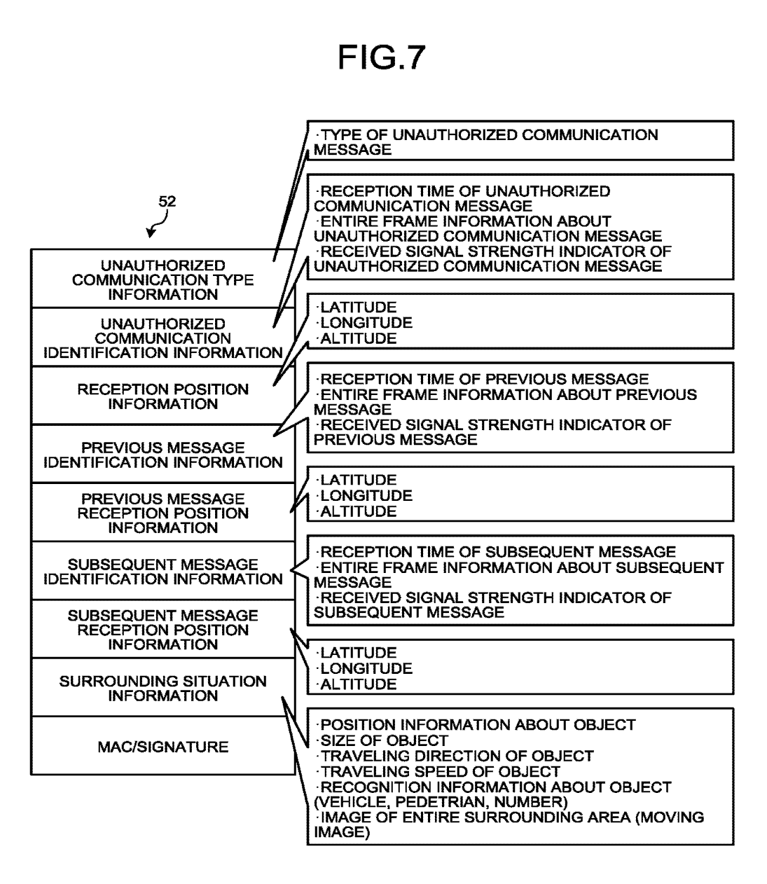

FIG. 6 is a schematic diagram showing examples of a data configuration of a communication message 50.

A communication message 50 includes at least an apparatus ID and either reference position or event occurrence position information. The apparatus ID included in the communication message 50 is the identification information about the communication apparatus 20 that is the source of transmission of the communication message 50. The reference position information is the position information about the communication apparatus 20 that is the source of transmission of the communication message 50. The event occurrence position information is position information indicating a position where an event to be notified of occurs.

The communication message 50 may further include a message authentication code (MAC) of the communication message 50 and a digital signature (hereinafter, may be referred to simply as a signature) on the communication message 50. The communication message 50 may further include other information.

For example, a communication apparatus 20 transmits and receives various types of communication messages 50 to/from the other communication apparatuses 20. FIG. 6 shows a cooperative recognition message 50A and a distributed environment notification message 50B as examples of communication messages 50.

The cooperative recognition message 50A is a communication message 50 transmitted to notify the other communication apparatuses 20 of information about the vehicle 2 on a regular basis.

The cooperative recognition message 50A includes a plurality of fields. In the example shown in FIG. 6, the cooperative recognition message 50A includes header, apparatus ID, situation property, reference position, and MAC/signature fields.

The header field includes information such as the version number of a communication protocol, a type of the communication message, and communication message generation time. For example, the type of the communication message is information indicating whether the communication message is a cooperative recognition message 50A or a distributed environment notification message 50B. The communication message generation time indicates the time when this cooperative recognition message 50A (communication message 50) is generated. The apparatus ID field includes the apparatus ID of the communication apparatus 20 that is the source of transmission of the cooperative recognition message 50A. The situation property field includes information representing situation properties of the communication apparatus 20 that is the source of transmission of the cooperative recognition message 50A. For example, the situation property field includes information indicating whether the communication apparatus 20 is a mobile apparatus, whether the communication apparatus 20 is a private apparatus, whether the communication apparatus 20 is a public apparatus, and whether the communication apparatus 20 is a physically related apparatus.

The reference position field includes reference position information. In the example shown in FIG. 6, the reference position field of the cooperative recognition message 50A includes information such as the position information (latitude, longitude, and altitude) and the traveling direction of the communication apparatus 20 that is the source of transmission of the cooperative recognition message 50A. The MAC/signature field includes a message authentication code and a digital signature for implementing message authentication.

The distributed environment notification message 50B is a communication message 50 transmitted to notify the other communication apparatuses 20 of an occurred event when the communication apparatus 20 detects the occurrence of the event in the vehicle 2 or the surrounding area of the vehicle 2. Examples of the event include heavy braking, an accident, a traffic jam, road construction, a possibility of collision, and a change in the weather. The distributed environment notification message 50B is repeatedly transmitted until expiration.

The distributed environment notification message 50B includes a plurality of fields. In the example shown in FIG. 6, the distributed environment notification message 50B includes header, management, situation, event occurrence position, tracing position, and MAC/signature fields.

The header field and the MAC/signature field of the distributed environment notification message 50B are the same as those of the cooperative recognition message 50A.

The management field includes information such as an apparatus ID, a sequence number, a data version, expiration time, the frequency of transmission, reliability, and an invalidation instruction.

The apparatus ID in the management field is the apparatus ID of the communication apparatus 20 that is the source of transmission of this distributed environment notification message 50B. The sequence number is a number assigned event by event. The data version is information representing a change of the event. The expiration time indicates the time of expiration of the event. The frequency of transmission indicates the frequency how often the transmission of the distributed environment notification message 50B is repeated. The reliability indicates the reliability of the event represented by the distributed environment notification message 50B. The invalidation instruction represents an instruction for event invalidation.

The situation field includes information representing the event to be notified of and the degree of significance of the event. The event occurrence position field includes event occurrence position information. The event occurrence position information is expressed by a latitude, longitude, and altitude. The tracing position field includes information representing a moving locus of the communication apparatus 20. For example, the information representing the moving locus is expressed by a group of pairs of a trace ID and a latitude, longitude, and altitude.

As described above, a communication message 50 includes at least the apparatus ID and position information (reference position information or event occurrence position information).

The unauthorized communication determiner 30J of the communication apparatus 20 determines whether the communication message 50 received from another communication apparatus 20 is an unauthorized communication message. In other words, the unauthorized communication determiner 30J determines whether the received communication message 50 is an unauthorized communication message or a normal communication message.

An unauthorized communication message refers to a communication message that is difficult to be handled as a normal communication message among the communication messages communicated between the communication apparatuses 20. In other words, an unauthorized communication message is a communication message other than normal communication messages.

An example of an unauthorized communication message is a communication message transmitted from another communication apparatus 20 with the intension of communication jamming or “spoofing.” Some unauthorized communication messages can be deliberately or intentionally transmitted from other communication apparatuses 20. Some can be transmitted from other communication apparatuses 20 by accident.

In the present embodiment, the unauthorized communication determiner 30J obtains the communication message 50 received by the communication unit 32B, the reception time of the communication message 50, and the received signal strength indicator of the communication message 50 from the communication message storage 37G.

The unauthorized communication determiner 30J then determines whether the communication message 50 received by the communication unit 32B is an unauthorized communication message. In the present embodiment, the unauthorized communication determiner 30J determines the communication message 50 to be an unauthorized communication message in at least any one of the following cases: the communication message 50 is one generated by a replay attack; the generation time of the communication message 50 is a certain time or more earlier; the generation time of the communication message 50 is in the future; the position corresponding to the communication message 50 is a certain distance or more away from the reception position of the communication message 50; the apparatus ID of the communication apparatus 20 that is the source of transmission of the communication message 50 is registered in the invalidation list; the communication message 50 has an incorrect MAC or signature; and the surrounding situation indicated by the communication message 50 is inconsistent with the actual surrounding condition.

For example, the unauthorized communication determiner 30J determines whether the received communication message 50 is identical to one received in the past. Being “identical” refers to that all the contents of the communication messages 50 are the same. By this determination, the unauthorized communication determiner 30J determines whether the received communication message 50 is one generated by a replay attack. For such a purpose, the communication message storage 37G can store communication messages 50 received by the communication unit 32B for a predetermined period. The unauthorized communication determiner 30J then determines whether the received new communication message 50 is identical to one received in the past, and thereby determines whether the communication message 50 is one generated by a replay attack.

The unauthorized communication determiner 30J may use a Bloom filter, a hash list, or the like to determine whether the received new communication message 50 is identical to any one of communication messages 50 received in the past.

The unauthorized communication determiner 30J can compare the communication message generation time included in the received communication message 50 with the current time to determine whether the generation time of the communication message 50 is a certain time or more earlier and whether the generation time of the communication message 50 is in the future. The unauthorized communication determiner 30J can thereby make determinations based on the validity of the received communication message 50.

The unauthorized communication determiner 30J compares the reference position information or event occurrence position information included in the received communication message 50 with the position information about the current position of the communication apparatus 20. By this comparison, the unauthorized communication determiner 30J determines whether the position corresponding to the communication message 50 (the reference position information or event occurrence position information) is a certain distance or more away from the reception position of the communication message 50 (the current position of the communication apparatus 20).

The unauthorized communication determiner 30J determines whether the apparatus ID included in the received communication message 50 is registered in the invalidation list. The invalidation list may be obtained in advance. Specifically, the authentication information acquirer 30I transmits an authentication acquisition request to the authentication apparatus 7 via the communication unit 33A. Receiving the authentication acquisition request, the authentication apparatus 7 transmits the authentication information including the invalidation list and the encryption key to the communication apparatus 20. The authentication information acquirer 30I of the communication apparatus 20 obtains the authentication information via the communication unit 33A, and stores the authentication information into the authentication information storage 37E. The authentication information acquirer 30I also outputs the authentication information to the unauthorized communication determiner 30J. Using the authentication information accepted from the authentication information acquirer 30I, the unauthorized communication determiner 30J can determine whether the apparatus ID included in the received communication message 50 is registered in the invalidation list.

The unauthorized communication determiner 30J may obtain authentication information further including a message authentication code (MAC) and a digital signature from the authentication apparatus 7 via the authentication information acquirer 30I and the communication unit 33A. The unauthorized communication determiner 30J then determines whether any of the MAC and signature of the received communication message 50 is incorrect.

The unauthorized communication determiner 30J determines whether the surrounding situation indicated by the communication message 50 is inconsistent with the actual surrounding situation in the following manner.

For example, if the received communication message 50 is a distributed environment notification message 50B, the processor 30 determines whether the event occurrence position information and the event included in the distributed environment notification message 50B are inconsistent with the actual surrounding situation information generated by the surrounding situation generator 30G. If the received communication message 50 is a cooperative recognition message 50A, the unauthorized communication determiner 30J determines whether the position represented by the reference position information included in the cooperative recognition message 50A is inconsistent with the actual surrounding situation information generated by the surrounding situation generator 30G. The unauthorized communication determiner 30J can read the surrounding situation information generated by the surrounding situation generator 30G from the surrounding situation storage 37D. The unauthorized communication determiner 30J similarly processes tracing position information.

Specifically, on the basis of the surrounding situation information, if it is difficult for the vehicle 2 on which the communication apparatus 20 is mounted to reach the position represented by the position information (reference position information or event occurrence position information) included in the communication message 50, the unauthorized communication determiner 30J determines that the position is inconsistent with the surrounding situation information. Examples of the case where it is difficult for the vehicle 2 to reach the position include when a moving speed higher than a predetermined speed (for example, 500 km/h) is needed. In another example, if the communication message 50 is a distributed environment notification message 50B, the event included in the distributed environment notification message 50B may represent heavy braking or a possibility of collision. In such a case, if no movable object 46 (for example, vehicle 2) is found in the surrounding situation information at the position represented by the event occurrence position information included in the distributed environment notification message 50B, the unauthorized communication determiner 30J determines that the position is inconsistent with the surrounding situation.

In such a manner, the unauthorized communication determiner 30J determines whether the communication message 50 received by the communication unit 32B is an unauthorized communication message.

If the communication message 50 received by the communication unit 32B is determined to be an unauthorized communication message, the unauthorized communication determiner 30J outputs the unauthorized communication message to the notification message generator 30L.

If the unauthorized communication determiner 30J determines the communication message 50 to be an unauthorized communication message, the notification message generator 30L generates a notification message. The notification message is a message for notifying the server apparatus 10 of information about the unauthorized communication message determined by the unauthorized communication determiner 30J. Each time the unauthorized communication determiner 30J determines a communication message to be an unauthorized communication message, the notification message generator 30L generates a notification message to notify of the notification communication message. The notification message generator 30L thus generates one notification message for each unauthorized communication message to be notified of. The notification message may be generated shortly afterward to include subsequent message identification information and subsequent message reception position information. For example, if communication messages having the same contents are being repeatedly received, the notification message generator 30L may wait until a different communication message is received. The notification message generator 30L may use a timer or the like to generate the notification message after a certain time.

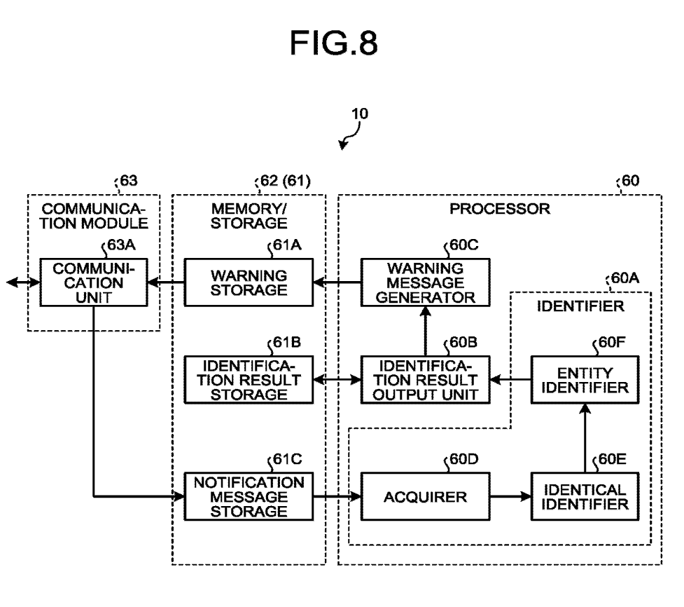

FIG. 7 is a schematic diagram showing an example of a data configuration of a notification message 52.

A notification message 52 includes at least unauthorized communication identification information and reception position information. The notification message 52 may preferably further include surrounding situation information. The notification message 52 may preferably further include identification information such as previous message identification information and subsequent message identification information, as well as a MAC and a signature. The notification message 52 may further include other information.

In the example shown in FIG. 7, the notification message 52 includes unauthorized communication type information, unauthorized communication identification information, reception position information, previous message identification information, previous message reception position information, subsequent message identification information, subsequent message reception position information, surrounding situation information, and a MAC/signature.

The unauthorized communication type information is information representing the type of the unauthorized communication message to be notified of. In the present embodiment, the unauthorized communication type information represents a factor from which the communication message is determined to be an unauthorized communication message by the unauthorized communication determiner 30J. In other words, the unauthorized communication type information is information representing from what determination result of the unauthorized communication determiner 30J the communication message is determined to be an unauthorized communication message. Examples of the unauthorized communication type information include information representing a replay attack.

The unauthorized communication identification information is information for identifying the unauthorized communication message to be notified of.

For example, the unauthorized communication identification information includes the reception time when the communication apparatus 20 receives the unauthorized communication message to be notified of, and entire frame information about the unauthorized communication information. The entire frame information about the unauthorized communication message includes at least any one of the entire frame of the unauthorized communication message and a summarized value of the entire frame of the unauthorized communication message. The entire frame includes the header and the footer in the data link layer. For example, in the IEEE 802.11 standard, the entire frame refers to data from an IEEE 802.11 header to a frame check sequence (FCS). The entire frame may also include information such as a preamble included in the physical layer header. The summarized value may be any value that is determined from the entire frame of the unauthorized communication message to be notified of by a fixed calculation method. An example of the summarized value is a hash value. The unauthorized communication identification information may further include the received signal strength indicator of the unauthorized communication message during reception.

The notification message generator 30L may read, from the communication message storage 37G, the reception time and the received signal strength indicator corresponding to the unauthorized communication message to be notified of, and include the reception time and the received signal strength indicator into the unauthorized communication identification information.

The reception position information included in the notification message 52 is position information indicating the position of the communication apparatus 20 receiving the unauthorized communication message to be notified of, when the unauthorized communication message is received. The notification message generator 30L may use the position information measured by the GNSS module 31 at the reception time of the unauthorized communication message as the reception position information about the unauthorized communication message. If the position of the own apparatus obtained from the surrounding situation information has higher accuracy than that of the GNSS module 31, the notification message generator 30L may use that position information.

The previous message identification information is identification information for identifying one or a plurality of other communication messages 50 received before the unauthorized communication message to be notified of. The identification information includes the entire frame(s) of the communication message(s) 50 or a summarized value(s) of the entire frame(s) of the communication message(s) 50, the reception time(s) of the communication message(s) 50, and the received signal strength indicator(s) of the communication message(s) 50.

The other communication message(s) 50 received before the unauthorized communication message to be notified of may be another communication message 50 received immediately before the unauthorized communication message to be notified of. The other communication message(s) 50 received before the unauthorized communication message to be notified of may be one or a plurality of other communication messages 50 received within a period between the reception of the unauthorized communication message and a predetermined time before. The other communication message(s) 50 may be either an unauthorized or normal communication message(s).

The previous message reception position information is position information indicating the reception position(s) of the communication apparatus 20 when the other communication message(s) 50 identified by the previous message identification information is/are received by the communication apparatus 20.

The subsequent message identification information is identification information for identifying one or a plurality of other communication messages 50 received after the unauthorized communication message to be notified of. The identification information includes the entire frame(s) of the communication message(s) 50 or a summarized value(s) of the entire frame(s) of the communication message(s) 50, the reception time(s) of the communication message(s) 50, and the received signal strength indicator(s) of the communication message(s) 50.

The other communication message(s) 50 received after the unauthorized communication message to be notified of may be another communication message 50 received immediately after the unauthorized communication message to be notified of. The other communication message(s) 50 received after the unauthorized communication message to be notified of may be one or a plurality of other communication messages 50 received within a period between the reception of the unauthorized communication message and a predetermined time later. The other communication message(s) 50 may be either an unauthorized or normal communication message(s).

The subsequent message reception position information is position information indicating the reception position(s) of the communication apparatus 20 when the other communication message(s) 50 identified by the subsequent message reception position information is/are received by the communication apparatus 20.

The notification message 52 preferably includes at least any one of the previous message identification information and the subsequent message identification information.

The surrounding situation information included in the notification message 52 is surrounding situation information representing the surrounding situation of the communication apparatus 20 receiving the unauthorized communication message to be notified of, when the unauthorized communication message to be notified of is received. The notification message generator 30L may read the surrounding situation information corresponding to the reception time of the unauthorized communication message from the surrounding situation storage 37D. For such a purpose, the surrounding situation storage 37D can successively store pieces of surrounding situation information generated by the surrounding situation generator 30G at different times, in association with the respective times of generation of the surrounding situation information. The notification message generator 30L can then read the surrounding situation information corresponding to a time of generation from the surrounding situation storage 37D by using the reception time of the unauthorized communication message to be notified of as the time of generation.

The MAC and the signature included in the notification message 52 may be generated by the notification message generator 30L and attached to the notification message 52. The MAC and the signature are attached for the purpose of securing the integrity of the notification message 52.

Returning to FIG. 4, a further description will now be given. The notification message generator 30L outputs the generated notification message 52 to the output unit 30M. The output unit 30M stores the notification message 52 accepted from the notification message generator 50L into the notification message storage 37F, and transmits the notification message 52 to the server apparatus 10 via the communication unit 33A.

More specifically, if the unauthorized communication determiner 30J determines the communication message 50 to be an unauthorized communication message, the output unit 30M outputs the notification message 52 for notifying of the unauthorized communication message to the server apparatus 10. In the present embodiment, the server apparatus 10 includes an identifier. Details will be described later. The identifier is a functional unit for identifying the entity that transmits an unauthorized communication message on the basis of the unauthorized communication message. In other words, in the present embodiment, the output unit 30M outputs the notification message 52 to the identifier.

In the present embodiment, if the received communication message 50 is determined to be an unauthorized communication message, the communication apparatus 20 thus transmits the notification message 52 for notifying of the unauthorized communication message to the server apparatus 10.

On other hand, if the unauthorized communication determiner 30J determines that the communication message 50 received by the communication unit 32B is a normal communication message, the normal communication message is output to the communication message acquirer 30K. The communication message acquirer 30K outputs the accepted normal communication message to the surrounding situation generator 30G.

Obtaining the normal communication message from the communication message acquirer 30K, the surrounding situation generator 30G reflects the normal communication message on the surrounding situation information 40. Specifically, the surrounding situation generator 30G adds object recognition information 49 to a position corresponding to the position information (reference position information or event occurrence position information) included in the normal communication message in the surrounding situation information 40 (in FIG. 5, see point 48). If the object recognition information 49 corresponding to the normal communication message already exists, the surrounding situation generator 30G updates the object recognition information 49. For example, if the normal communication message is a distributed environment notification message 50B (see FIG. 6), the surrounding situation generator 30G adds object recognition information 49 to the position corresponding to the event occurrence position information about the event. If the object recognition information 49 corresponding to the normal communication message already exists, the surrounding situation generator 30G updates the object recognition information 49. In such a manner, the surrounding situation generator 30G generates the surrounding situation information 40.

Each time the surrounding situation generator 30G generates the surrounding situation information 40, the surrounding situation generator 30G analyzes the generated surrounding situation information 40. If the analysis of the surrounding situation information 40 detects an event to be notified to the other communication apparatuses 20, the surrounding situation generator 30G outputs a generation request for a communication message 50 to the communication message generator 30H.

Accepting the generation request for a communication message 50, the communication message generator 30H generates and transmits a communication message 50 to the other communication apparatuses 20 via the communication unit 32B. For example, if the communication message generator 30H is notified of an event by the surrounding situation generator 30G, the communication message generator 30H generates and transmits a distributed environment notification message 50B to the other communication apparatuses 20. For example, the distribution environment notification message 50B here includes “there is a vehicle traveling straight in a blind spot of the vehicle turning to the right” as the detected event.

The communication message generator 30H may generate and transmit a communication message 50 to the other communication apparatuses 20 via the communication unit 32B at predetermined time intervals. In such a case, the communication message generator 30H can generate and transmit a cooperative recognition message 50A to the other communication apparatuses 20 at predetermined time intervals.

The communication message generator 30H may store the generated communication message 50 into the communication message storage 37G before transmitting the communication message 50 to the other communication apparatuses 20.

As described above, the communication message 50 may include the surrounding situation information 40 that is used in generating the communication message 50. In such a case, the other communication apparatuses 20 receiving the communication message 50 can use the surrounding situation information 40 to identify travelable areas of the vehicles 2 on which the communication apparatuses 20 are mounted, under advanced driver assistance systems (ADAS) or autonomous driving.

Next, the functions of the server apparatus 10 will be described.

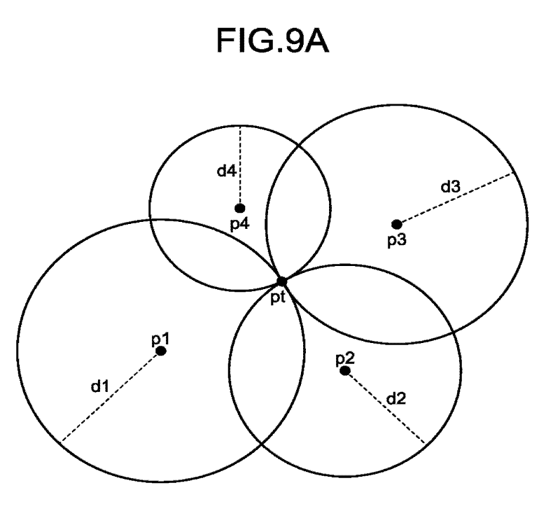

FIG. 8 is an example of a functional block diagram of the server apparatus 10.

The communication module 63 of the server apparatus 10 includes a communication unit 63A. The communication unit 63A communicates with one or a plurality of communication apparatuses 20, the map information management apparatus 6, and the authentication apparatus 7.

In the present embodiment, the communication unit 33A receives notification messages 52 from the communication apparatus(es) 20. The communication unit 33A stores the received notification messages 52 into a notification message storage 61C of the storage 62, and outputs the notification messages 52 to the processor 60.

The communication unit 33A transmits a warning message under the control of the processor 60. Details of the warning message will be described later.

The storage 62 stores various types of data. In the present embodiment, the storage 62 includes a warning storage 61A, an identification result storage 61B, and the notification message storage 61C.

At least one of the warning storage 61A, the identification result storage 61B, and the notification message storage 61C may be arranged in the memory 61. At least one of the warning storage 61A, the identification result storage 61B, and the notification message storage 61C may be a database, a file, a memory area (for example, a memory area reserved by an application or an OS), or any one of distinct storage media.

The processor 60 includes an identifier 60A, an identification result output unit 60B, and a warning message generator 60C. The identifier 60A includes an acquirer 60D, an identical identifier 60E, and an entity identifier 60F.

Part or all of the identifier 60A, the identification result output unit 60B, the warning message generator 60C, the acquirer 60D, the identical identifier 60E, and the entity identifier 60F may be implemented by causing a CPU or other processor to execute a program or programs, i.e., by software. Part or all of the units 60A to 60F may be implemented by hardware such as an IC. The units 60A to 60F may be implemented by using both software and hardware.

The identifier 60A identifies the entity that transmits an unauthorized communication message determined by the unauthorized communication determiner 30J of a communication apparatus 20 on the basis of the unauthorized communication message. As described above, the identifier 60A includes the acquirer 60D, the identical identifier 60E, and the entity identifier 60F.

The acquirer 60D obtains a plurality of notification messages 52. If the communication unit 63A receives notification messages 52 from the communication apparatus(es) 20, the communication unit 63A stores the received notification messages 52 into the notification message storage 61C in order. Here, the communication unit 63A may store the notification messages 52 into the notification message storage 61C in association with the reception times when the notification messages 52 are received.

Each time the communication unit 63A receives a new notification message 52, the acquirer 60D obtains a plurality of notification messages 52 including the notification message 52 from the notification message storage 61C. In the present embodiment, if the communication unit 63A receives a new notification message 52, the acquirer 60D obtains the notification message 52 and all the notification messages 52 received before the notification message 52 from the notification message storage 61C.

The identical identifier 60E identifies a plurality of notification messages 52 corresponding to an identical unauthorized communication message among the plurality of notification messages 52 obtained by the acquirer 60D. A plurality of notification messages 52 corresponding to the identical unauthorized communication message refer to a plurality of notification messages 52 notifying of the identical unauthorized communication message.

For example, the identical identifier 60E determines whether the entire frames of the unauthorized communication messages included in a plurality of respective notification messages 52, or the summarized values thereof (entire frame information about the unauthorized communication messages), are identical. The identical identifier 60E then identifies a plurality of notification messages 52 of which the entire frames of the included unauthorized communication messages or the summarized values thereof are identical. The identical identifier 60E thereby identifies a plurality of notification messages 52 corresponding to the identical unauthorized communication message.

The identical identifier 60E needs only to identify two or more notification messages 52 corresponding to the identical unauthorized communication message. However, in view of improved accuracy of entity identification, the identical identifier 60E preferably identifies four or more notification messages 52 corresponding to the identical unauthorized communication message. The identical identifier 60E therefore preferably repeats the reception of a new notification message 52 and the identification until four or more notification messages 52 corresponding to the identical unauthorized communication message are identified for each unauthorized communication message.

The entity identifier 60F identifies the entity that transmits the identical unauthorized communication message on the basis of the unauthorized communication identification information and the reception position information included in each of the plurality of notification messages 52 corresponding to the identical unauthorized communication message.

The entity identifier 60F identifies at least any one of the position of the entity transmitting the unauthorized communication message and recognition result information representing a recognition result of the entity.

For example, the entity identifier 60F reads the unauthorized communication identification information and the reception position information included in each of the notification messages 52 identified by the identical identifier 60E. The reception position information indicates the position of the communication apparatus 20 when the unauthorized communication message is received by the communication apparatus 20.

The entity identifier 60F then identifies the position of the entity by using a predetermined position identification method on the basis of the unauthorized communication identification information and the reception position information about each of the plurality of notification messages 52 corresponding to the identical unauthorized communication message. The position of the entity can be expressed by position information (latitude, longitude, and altitude) representing a position in the real space.

Examples of the predetermined position identification method include a time difference of arrival (TDOA) method and an RSSI (received signal strength indicator) method. Other known position identification methods may be used.

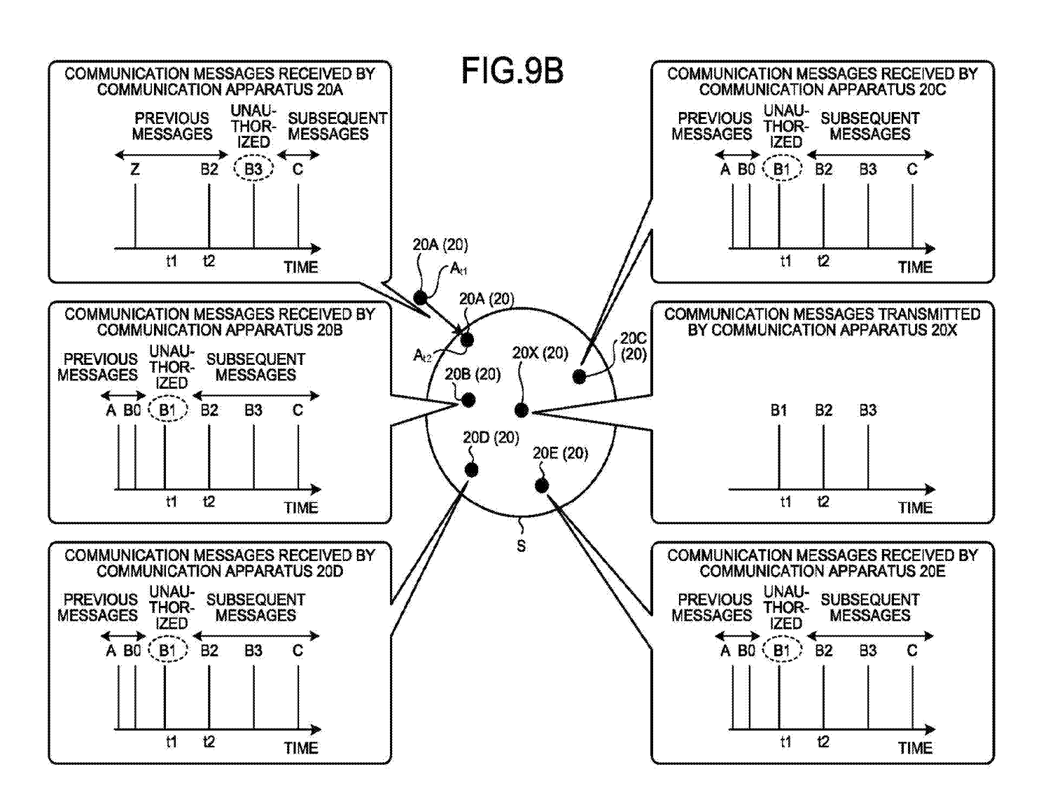

FIG. 9A is a conceptual diagram showing the position identification of an entity. For the sake of simple description, FIG. 9A shows a two-dimensional space. FIG. 9A shows a case in which the entity identifier 60F identifies four notification messages 52 corresponding to the identical unauthorized communication message. In FIG. 9A, positions p1 to p4 represent the positions indicated by the reception position information included in the respective notification messages 52. In FIG. 9A, a position pt represents the position of the entity identified by the entity identifier 60F.

In the case of using the TDOA method, the entity identifier 60F calculates distances (d1 to d4) between the communication apparatuses 20 transmitting the notification messages 52 and the entity transmitting the unauthorized communication message. The entity identifier 60F calculates the distances (d1 to d4) from differences between the reception times of the unauthorized communication message, included in the respective pieces of unauthorized communication identification information in the plurality of notification messages 52 corresponding to the identical unauthorized communication message. The entity identifier 60F identifies the position (in FIG. 9A, pt) of the entity by using the calculated distances (d1 to d4).

In the case of using the RSSI method, the entity identifier 60F calculates the distances (d1 to d4) between the communication apparatuses 20 transmitting the notification messages 52 and the entity transmitting the unauthorized communication message by using the received signal strength indicators of the unauthorized communication message included in the respective pieces of unauthorized communication identification information in the plurality of notification messages 52 corresponding to the identical unauthorized communication message. The entity identifier 60F identifies the position (in FIG. 9A, pt) of the entity by using the calculated distances (d1 to d4).

The entity identifier 60F may identify the position of the entity by a known position identification method, using the reception position information included in each of the plurality of notification messages 52 corresponding to the identical unauthorized communication message.

The entity identifier 60F may identify the position of the entity transmitting the unauthorized communication message by using a plurality of position identification methods in combination.

As described above, the notification messages 52 may further include surrounding situation information. In such a case, the entity identifier 60F identifies the position of the entity as described above. The entity identifier 60F further identifies object recognition information 49 including the position of an object 46 coincident with the identified position of the entity, as recognition result information representing the recognition result of the entity.

As described above, the object recognition information 49 includes at least one of the following: the position of the object 46, the size of the object 46, the traveling direction of the object 46, the traveling speed of the object 46, and the type of the object 46 (see FIG. 5). The entity identifier 60F can thus identify recognition result information including at least one of the position, size, traveling direction, traveling speed, and type of the entity transmitting the unauthorized communication message.

The entity identifier 60F can more accurately identify the position of the entity by using the object recognition information 49 including the position of the object 46 coincident with the identified position of the entity, in combination with the position of the entity identified by the foregoing position identification method.

As described above, the notification messages 52 may further include at least any one of previous message identification information and previous message reception position information and subsequent message identification information and subsequent message reception position information.

In such a case, the entity identifier 60F can more accurately identify the position of the entity by further using at least any one of the previous message identification information and previous message reception position information and the subsequent message identification information and subsequent message reception position information.

Specifically, by using at least any one of the previous message identification information and previous message reception position information and the subsequent message identification information and subsequent message reception position information, the entity identifier 60F excludes notification messages 52 corresponding to unauthorized communication messages transmitted from different entities or at different transmission times from among the plurality of notification messages 52 corresponding to the identical unauthorized communication message, identified by the identical identifier 60E. The entity identifier 60F then identifies the entity by using a remaining plurality of notification messages 52 other than those excluded among the plurality of notification messages 52 identified by the identical identifier 60E.

More specifically, by using at least any one of the previous message identification information and previous message reception position information and the subsequent message identification information and subsequent message reception position information, the entity identifier 60F excludes notification messages 52 corresponding to unauthorized communication messages transmitted from different entities or at different transmission times. In the following description, the notification messages 52 to be excluded may be referred to as exclusion target messages 53.

FIG. 9B is an explanatory diagram showing a method for excluding exclusion target messages 53 by using the previous message identification information and previous message reception position information and/or the subsequent message identification information and subsequent message reception position information.

FIG. 9B shows communication apparatuses 20A, 20B, 20C, 20D, 20E, and 20X as communication apparatuses 20. FIG. 9B shows a case in which the communication apparatus 20X receives a communication message 50 (B0) transmitted from another communication apparatus 20 (communication apparatuses 20A to 20E), and the communication apparatus 20X repeatedly transmits the same communication messages 50 (B1, B2, and B3) each time.

The circle S around the communication apparatus 20X represents the coverage of the communication messages 50 transmitted from the communication apparatus 20X. In this example, the communication apparatus 20A moves from position Aₜ₁ to position Aₜ₂ shown in FIG. 9B over time t1 to time t2, and stops at position Aₜ₂.

For ease of description, suppose that the other communication apparatuses 20 (20B, 20C, 20D, 20E, and 20X) do not move. At time t1, the communication apparatus 20A is outside the coverage of the communication messages 50 (B1, B2, and B3) transmitted from the communication apparatus 20X. When the communication apparatus 20A moves to position Aₜ₂ at time t2, the communication apparatus 20A receives the communication message B2. The communication apparatus 20A then receives the communication message B3.

Receiving the communication message 50 (B3), the communication apparatus 20A detects a replay attack and determines that the communication message 50 (B3) is an unauthorized communication message. The communication apparatus 20A then generates and transmits a notification message 52 and information about previous and subsequent messages to the server apparatus 10.

The information about previous and subsequent messages refers to the previous message identification information, the previous message reception position information, the subsequent message identification information, and the subsequent message reception position information.

Meanwhile, if the communication apparatuses 20B, 20C, 20D, and 20E receive the communication message 50 (B0) and then the communication message 50 (B1), the communication apparatuses 20B, 20C, 20D, and 20E detect a replay attack and determine that the communication message 50 (B1) is an unauthorized communication message. The communication apparatuses 20B, 20C, 20D, and 20E then generate and transmit a notification message 52 to the server apparatus 10.

The server apparatus 10 receives such notification messages 52. The identical identifier 60E of the server apparatus 10 then identifies a plurality of notification messages 52 corresponding to the identical unauthorized communication message. The identical identifier 60E thus determines that the communication message 50 (B1) and the communication message 50 (B3) corresponding to the notification messages 52 are the identical communication messages 50.

If the communication message 50 (B1) and the communication message 50 (B3) are handled as the identical communication messages 50, the position of the entity can be misidentified. To avoid such a misidentification, the entity identifier 60F excludes notification messages 52 (exclusion target messages 53) corresponding to different unauthorized communication messages by using the previous message identification information, the previous message reception position information, the subsequent message identification information, and the subsequent message reception position information.

For example, the entity identifier 60F checks communication messages 50 (C) for coincidence by using the subsequent message identification information and the subsequent message reception position information. The communication messages 50 (C) refer to communication messages 50 that the respective communication apparatuses 20 receive at timing after the communication message 50 (B3).

Specifically, the entity identifier 60F determines the position of the entity transmitting the unauthorized communication message (the transmission position of the unauthorized communication message) by using the subsequent message identification information and the subsequent message reception position information. The entity identifier 60F then performs matching between the communication messages 50. As a result, in the example shown in FIG. 9B, the entity identifier 60F can confirm that the unauthorized communication message corresponding to the notification message 52 received from the communication apparatus 20A matches the communication messages 50 (B3) identified from the subsequent message identification information in the notification messages 52 transmitted from the communication apparatuses 20B, 20C, 20D, and 20E. The entity identifier 60F then excludes the notification messages 52 corresponding to the communication messages 50 (B3) because although the data itself of the unauthorized communication messages is identical, the unauthorized communication messages are transmitted from different entities or at different timing.

In such a manner, the entity identifier 60F identifies the entity by further using at least any one of the previous message identification information and previous message reception position information and the subsequent message identification information and subsequent message reception position information. Such entity identification is particularly useful if there is a large number of identical communication messages. Examples include when the foregoing replay attack continues.

The entity identifier 60F may calculate reliability by a known weighted residuals algorithm or determine the presence of an affected node by an iterative minimum residual algorithm to exclude notification messages 52 affected by shadowing or multipathing.

Returning to FIG. 8, a further description will be given. If the entity identifier 60F identifies the entity transmitting the unauthorized communication message, the entity identifier 60F outputs an identification result to the identification result output unit 60B.

The identification result is information representing an identification result of the entity transmitting the unauthorized communication message. The identification result includes at least either the recognition result information about the entity or the position information indicating the position of the entity.

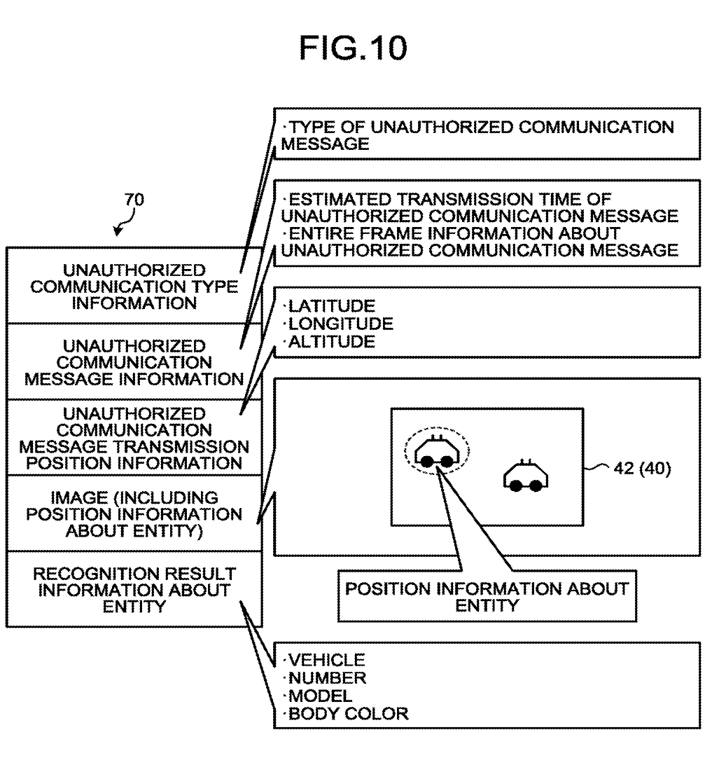

FIG. 10 is a schematic diagram showing an example of a data configuration of an identification result 70. The identification result 70 includes unauthorized communication type information, unauthorized communication message information, unauthorized communication message transmission position information, an image including the position information about the entity, and the recognition result information about the entity.

The unauthorized communication type information is the same as described above. The unauthorized communication message information includes the entire frame of the unauthorized communication message or a summarized value of the entire frame of the unauthorized communication message (entire frame information about the unauthorized communication message), and estimated transmission time of the unauthorized communication message.

The entity identifier 60F includes the entire frame of the unauthorized communication message or its summarized value used for the identification of the entity into the identification result 70. The entity identifier 60F reads the type of the authentication communication message used for the identification of the entity from the notification message 52 including the unauthorized communication message, and includes the type into the identification result 70.

The entity identifier 60F calculates the estimated transmission time at which the unauthorized communication message is estimated to be transmitted from the entity, by using the identified position of the entity and the reception time of the unauthorized communication message. The entity identifier 60F includes the calculated estimated transmission time into the identification result 70.

The entity identifier 60F includes the position information indicating the identified position of the entity into the identification result 70 as the unauthorized communication message transmission position information. The entity identifier 60F also includes an image including the position information about the identified entity into the identification result 70. The image may be the surrounding image 42 of the surrounding situation information 40 included in the notification message 52, on which the position information is plotted at a position corresponding to the position information about the identified entity. This image may be a moving image including surrounding images before and after the transmission of the unauthorized communication message, instead of a still image. The image may further include other information such as a degree of certainty of the position information about the entity. The identification result 70 may include the surrounding situation information 40.

As described above, the recognition result information about the entity includes at least one of the position, size, traveling direction, traveling speed, and type of the entity transmitting the unauthorized communication message.

The entity identifier 60F outputs the identification result 70 to the identification result output unit 60B.

Returning to FIG. 8, a further description will be given. The identification result output unit 60B stores the identification result 70 accepted from the entity identifier 60F into the identification result storage 61B. The identification result output unit 60B also outputs the identification result 70 to the warning message generator 60C. The identification result output unit 60B may transmit the identification result 70 accepted from the identifier 60A to an external apparatus via the communication unit 63A.

The warning message generator 60C accepts the identification result 70 from the identification result output unit 60B. If the warning message generator 60C determines that a predetermined condition is satisfied, the warning message generator 60C generates a warning message.

The predetermined condition may be set in advance. Examples of the predetermined condition include that vehicles 2 having the same number are transmitting the unauthorized communication message from a plurality of mutually different points, and that the unauthorized communication message is frequently transmitted from the same position.

The warning message generator 60C stores the generated warning message into the warning storage 61A, and transmits the warning message to an external apparatus via the communication unit 63A. Examples of the external apparatuses include a communication apparatus 20 and a management server that manages a traffic state etc. The warning message transmitted from the warning message generator 60C can be used for traffic regulation activities and the like.

Next, processing procedures performed by the processor 30 of the communication apparatus 20 will be described.

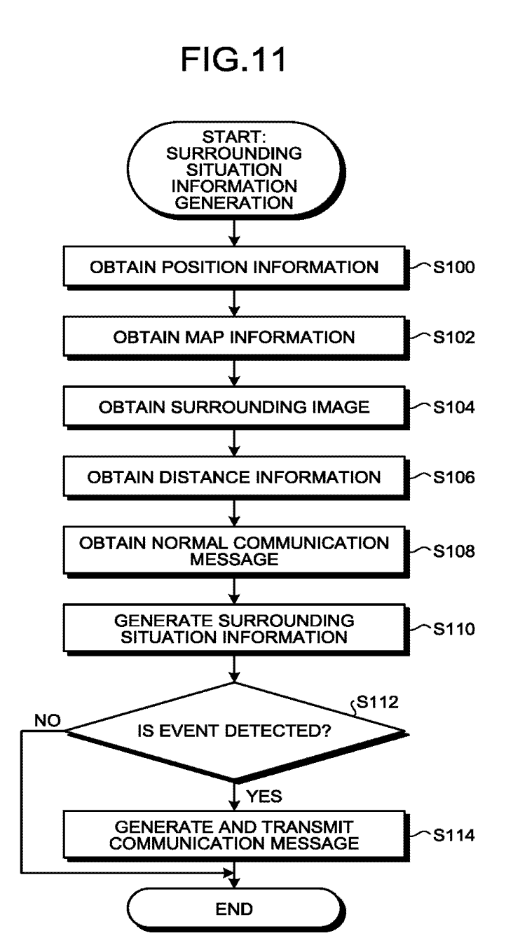

FIG. 11 is a flow chart showing an example of a procedure of surrounding situation information generation processing performed by the processor 30 of the communication apparatus 20.

Initially, the position acquirer 30A obtains position information from the position output unit 31A (step S100). Next, the map acquirer 30F obtains map information from the map information management apparatus 6 via the communication unit 33A (step S102). Next, the image acquirer 30D obtains a surrounding image 42 from the image output unit 34A (step S104). Next, the distance acquirer 30E obtains distance information from the distance output unit 35A (step S106).

The surrounding situation generator 30G obtains a normal communication message from the communication message acquirer 30K (step S108). The surrounding situation generator 30G generates surrounding situation information 40 on the basis of the position information, the map information, the surrounding image, the distance information corresponding to the same time (current time), obtained in steps S100 to S106. The surrounding situation generator 30G reflects the normal communication message on the surrounding situation information 40. By such processing, the surrounding situation generator 30G generates the surrounding situation information 40 (step S110).

Next, the surrounding situation generator 30G determines whether an event to be notified to the other communication apparatuses 20 is detected as a result of the generation of the surrounding situation information 40 (step S112). If the determination in step S112 is positive (step S112: Yes), the processing proceeds to step S114. In step S114, the communication message generator 30H generates and transmits a new communication message 50 to the other communication apparatuses 20 via the communication unit 32B (step S114). The present routine ends. If the determination in step S112 is negative (step S112: No), the present routine ends.

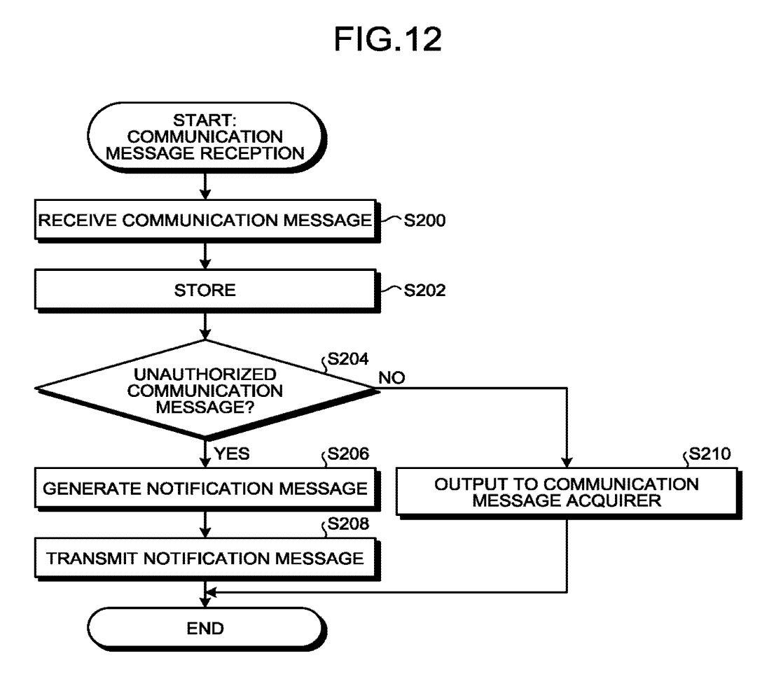

Next, an example of a procedure of communication message reception processing performed by the processor 30 of the communication apparatus 20 will be described. FIG. 12 is a flow chart showing an example of the procedure of the communication message reception processing performed by the processor 30 of the communication apparatus 20.

Initially, the communication unit 32B receives a new communication message 50 from another communication apparatus 20 (step S200). The communication unit 32B stores the received communication message 50, the reception time of the communication message 50, and the received signal strength indicator of the communication message 50 into the communication message storage 37G in association with each other (step S202).

Next, the unauthorized communication determiner 30J determines whether the communication message 50 received in step S200 is an unauthorized communication message (step S204). Details of the determination processing of step S204 will be described later.

If the communication message 50 is determined to be an unauthorized communication message in step S204 (step S204: Yes), the processing proceeds to step S206. In step S206, the notification message generator 30L generates a notification message 52 for notifying of the unauthorized communication message (step S206).

Next, the output unit 30M transmits the notification message 52 generated in step S206 to the server apparatus 10 via the communication unit 32B (step S208). The present routine ends.

On the other hand, if the communication message is determined to not be an unauthorized communication message in step S204 (step S204: No), the processing proceeds to step S210. In step S210, the unauthorized communication determiner 30J outputs the communication message 50 determined to not be an unauthorized communication message to the communication message acquirer 30K as a normal communication message (step S210). The present routine ends.

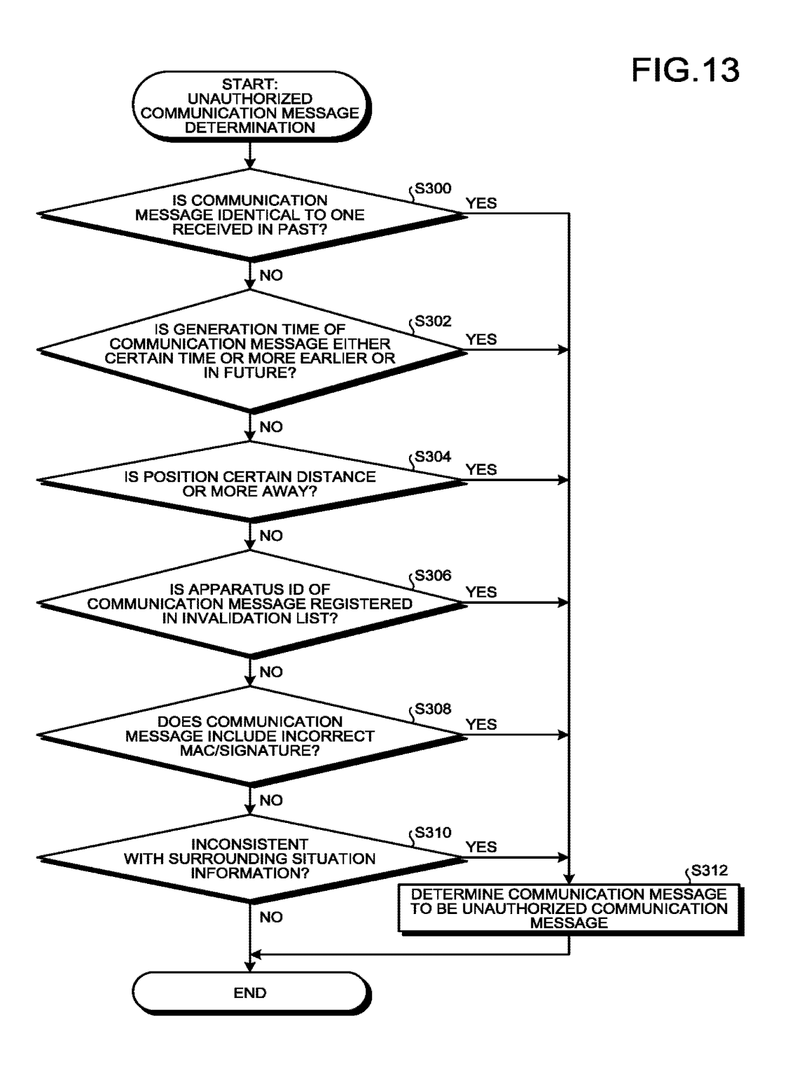

Next, the processing for determining whether the communication message is an unauthorized communication message in FIG. 12 (step S204) will be described in detail. FIG. 13 is a flow chart showing an example of a procedure of unauthorized communication message determination processing.

Initially, the unauthorized communication determiner 30J determines whether the communication message 50 received by the communication unit 32B is identical to one received in the past (step S300). By the determination processing of step S300, the unauthorized communication determiner 30J determines whether the communication message 50 is one generated by a replay attack. If the determination in step S300 is positive (step S300: Yes), the processing proceeds to step S312 to be described later.

If the determination in step S300 is negative (step S300: No), the processing proceeds to step S302. In step S302, the unauthorized communication determiner 30J determines whether the generation time of the communication message 50 received by the communication unit 32B is either a certain time or more earlier or in the future (step S302). If the determination in step S302 is positive (step S302: Yes), the processing proceeds to step S312.

If the determination in step S302 is negative (step S302: No), the processing proceeds to step S304. In step S304, the unauthorized communication determiner 30J determines whether the position corresponding to the communication message 50 is a certain distance or more away from the reception position of the communication message 50 (step S304). If the determination in step S304 is positive (step S304: Yes), the processing proceeds to step S312.

If the determination in step S304 is negative (step S304: No), the processing proceeds to step S306. In step S306, the unauthorized communication determiner 30J determines whether the apparatus ID included in the communication message 50 is registered in the invalidation list (step S306). If the determination in step S306 is positive (step S306: Yes), the processing proceeds to step S312.

If the determination in step S306 is negative (step S306: No), the processing proceeds to step S308. In step S308, the unauthorized communication determiner 30J determines whether the communication message 50 includes an incorrect MAC and/or signature (step S308). If the determination in step S308 is positive (step S308: Yes), the processing proceeds to step S312.

If the determination in step S308 is negative (step S308: No), the processing proceeds to step S310. In step S310, the unauthorized communication determiner 30J determines whether the surrounding situation indicated by the communication message 50 is inconsistent with the actual surrounding situation (step S310). If the determination in step S310 is positive (step S310: Yes), the processing proceeds to step S312. If the determination in step S310 is negative (step S310: No), the present routine ends.

In step S312, the unauthorized communication determiner 30J determines the communication message 50 received by the communication unit 32B to be an unauthorized communication message (step S312). The present routine ends.

Next, processing procedures performed by the processor 60 of the server apparatus 10 will be described.

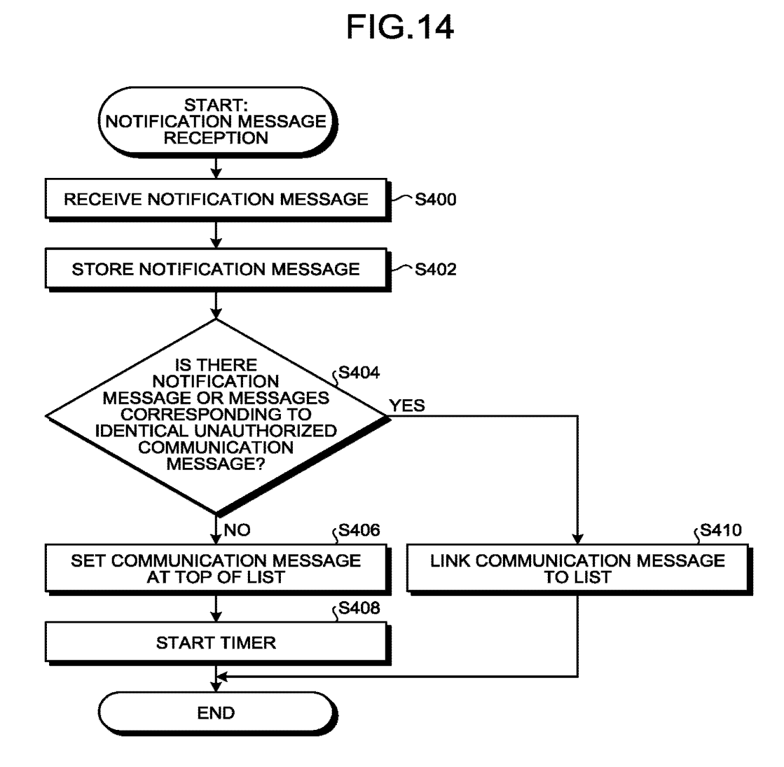

FIG. 14 is a flow chart showing an example of a procedure of notification message reception processing performed by the processor 60 of the server apparatus 10.

Initially, the communication unit 63A of the server apparatus 10 receives a new notification message 52 from a communication apparatus 20 (step S400). The communication unit 63A stores the received notification message 52 into the notification message storage 61C (step S402).

Next, the identical identifier 60E identifies a plurality of notification messages 52 corresponding to the identical unauthorized communication message. For example, the identical identifier 60E prepares a hash table for managing notification messages 52 stored in the notification message storage 61C.

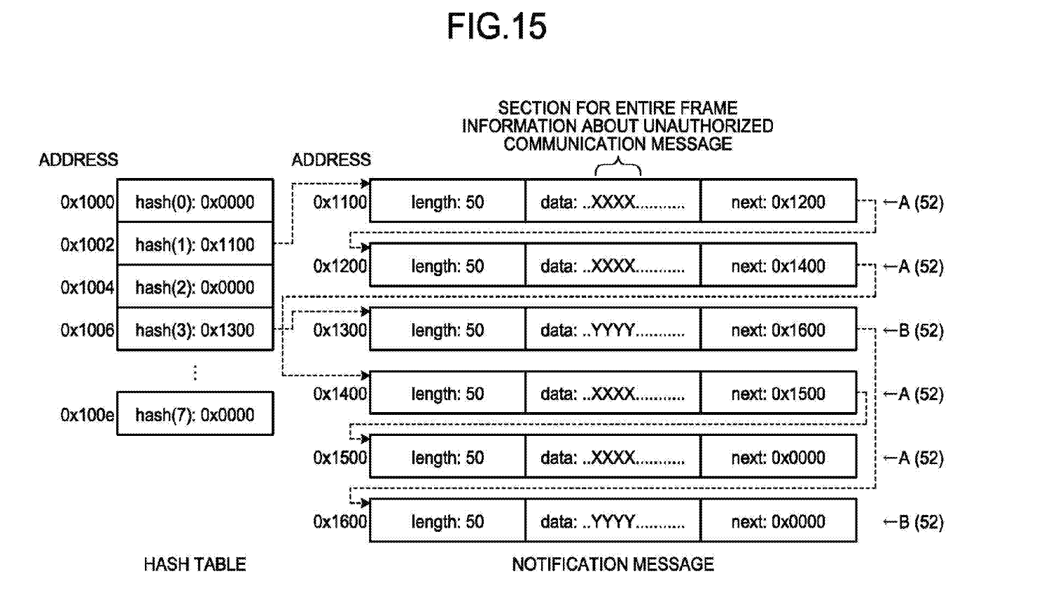

FIG. 15 is a schematic diagram showing an example of a data configuration of the hash table. Suppose, for example, that the notification message storage 61C stores the hash table, a plurality of notification messages 52 corresponding to an unauthorized communication message A, and a plurality of notification messages 52 corresponding to an unauthorized communication message B. The hash table contains addresses at which notification messages are stored, with respect to respective hash values 0 to 7. The address 0x0000 represents that no notification message corresponding to that hash value is stored yet. The entire hash table is initialized to 0x0000.

For example, a notification message may be stored in the form of a structure including members length, data, and next. length represents the length of the notification message. data contains the data of the notification message. next is a pointer to the next notification message for the notification message to be linked to in a list. If next is 0x0000, it represents the end of the list. next is initialized to 0x0000 when each notification message is received.

If the identical identifier 60E receives a notification message, the identical identifier 60E determines a hash value from the unauthorized communication message included in the unauthorized communication identification information of the notification message by using a predetermined hash function. The identical identifier 60E checks the value stored in the hash table corresponding to the hash value.

If the value of the hash table corresponding to the hash value is other than 0x0000, in other words, if a notification message having the same hash value is already received, the identical identifier 60E searches the list in the stored address until a notification message in which the number next is 0x0000 is found. If the identical identifier 60E finds a notification message in which next is 0x0000, the identical identifier 60E stores the address of the received notification message into that next (hereinafter, referred to as link the notification message to the list).

Suppose, on the other hand, that there is no other notification message 52 corresponding to the identical unauthorized communication message, i.e., that the value of the hash table corresponding to the hash value determined from the unauthorized communication message included in the unauthorized communication identification information of the notification message is 0x0000. In such a case, the identical identifier 60E sets the value of the hash table to the address of the notification message 52 (hereinafter, referred as set the notification message at the top of a list).

Returning to FIG. 14, a further description will be given. The identical identifier 60E determines whether there is a notification message or messages 52 corresponding to the identical unauthorized communication message (step S404). If the determination in step S404 is negative (step S404: No), the processing proceeds to step S406. In step S406, the identical identifier 60E sets the notification message 52 at the top of a list (step S406). The identical identifier 60E then starts a timer with the set timing of step S406 as count “0” (step S408). The present routine ends.

On the other hand, if the determination in step S404 is positive (step S404: Yes), the processing proceeds to step S410. In step S410, the identical identifier 60E links the notification message 52 to the list (step S410). The present routine ends.

The entity identifier 60F then identifies a timer of which the count value exceeds a predetermined value among the timers started for the respective identical unauthorized communication messages in the communication message reception processing shown in FIG. 14 (timers started in step S408). The entity identifier 60F performs entity identification processing by using a plurality of notification messages 52 according to the identical unauthorized communication message corresponding to the identified timer.

Specifically, the entity identifier 60F performs entity identification processing for identifying the entity transmitting the unauthorized communication message on the basis of the plurality of notification messages 52 corresponding to the identical unauthorized communication message.

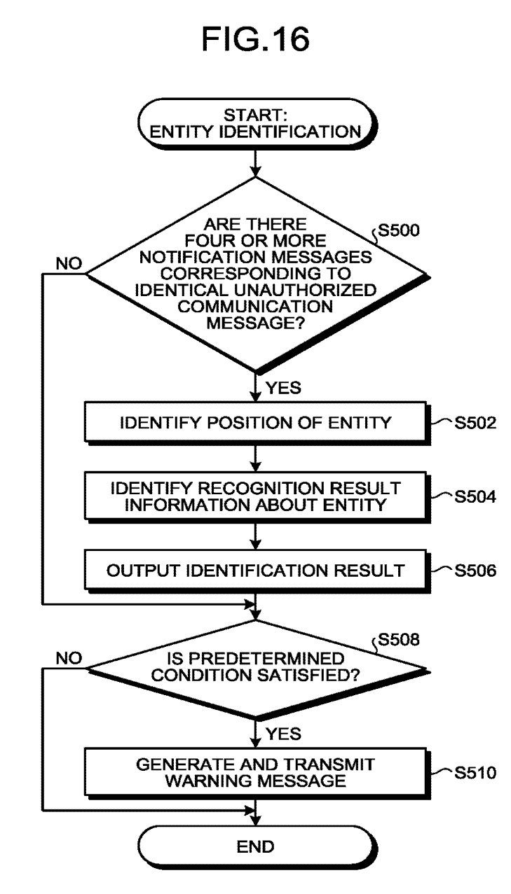

FIG. 16 is a flow chart showing an example of a procedure of the entity identification processing performed by the processor 60 of the server apparatus 10.

Initially, the entity identifier 60F determines whether there are four or more notification messages 52 corresponding to the identical unauthorized communication message (step S500). As described above, the entity identifier 60F may identify the entity by using at least two or more notification messages 52 corresponding to the identical unauthorized communication message. FIG. 16 shows a case in which four or more notification messages 52 are used as an example of preferable processing in view of improved accuracy of entity identification.

If the determination in step S500 is negative (step S500: No), the processing proceeds to step S508 to be described later. On the other hand, if the determination in step S500 is positive (step S500: Yes), the processing proceeds to step S502. In step S502, the entity identifier 60F identifies the position of the entity transmitting the unauthorized communication message by using the plurality of notification messages 52 corresponding to the identical unauthorized communication message (step S502).

Next, the entity identifier 60F identifies recognition result information about the entity transmitting the unauthorized communication message by using the plurality of notification messages 52 corresponding to the identical unauthorized communication message (step S504).

Next, the entity identifier 60F outputs an identification result 70 including at least any one of the identified position of the entity and the identified recognition result information representing the recognition result of the entity to the identification result output unit 60B. The identification result output unit 60B outputs the identification result 70 accepted from the entity identifier 60F to the warning message generator 60C (step S506). As described above, the identification result output unit 60B may transmit the identification result 70 accepted from the entity identifier 60F to an external apparatus via the communication unit 63A.

Next, the warning message generator 60C determines whether a predetermined condition is satisfied (step S508). If the determination in step S508 is negative (step S508: No), the present routine ends. On the other hand, if the determination in step S508 is positive (step S508: Yes), the processing proceeds to step S510.

In step S510, the warning message generator 60C generates and stores a warning message into the warning storage 61A, and transmits the warning message to an external apparatus via the communication unit 63A (step S510). The present routine ends. The warning message generator 60C may delete the processing-completed notification messages 52 corresponding to the identical unauthorized communication message from the notification message storage 61C. In so doing, the warning message generator 60C performs the processing to maintain the list connection of the other notification messages having the same hash value.

As described above, the communication apparatus 20 of the present embodiment includes the communication unit 32B and the output unit 30M. The communication unit 32B receives an unauthorized communication message. On the basis of the unauthorized communication message, the output unit 30M outputs a notification message 52 including unauthorized communication identification information for identifying the unauthorized communication message and reception position information. The unauthorized communication identification information includes the entire frame information about the unauthorized communication message. The reception position information indicates the position of the communication apparatus 20 when the unauthorized communication message is received.

Such a notification message 52 has not been transmitted heretofore. For example, V2X communications such as the IEEE 802.11p-based communications between vehicles (V2V), communications between a vehicle and a communication apparatus (V2I), communications between a vehicle and a pedestrian (V2P), and communications between a vehicle and a home (V2H) have used a wildcard BSSID (Basic Service Set IDentification) to perform communication without establishing a BSS. It has heretofore been difficult to identify entities since unauthorized communication messages can be simultaneously transmitted from different positions where radio waves do not interfere with each other.

Conventionally, in the infrastructure mode, encryption corresponding to transmission source MAC addresses has been performed to verify the authenticity of the entities transmitting communication messages. However, in V2X communications, transmission source MAC addresses are unfixed for the sake of securing anonymity. If a V2X message is transmitted, the message has heretofore been not able to be associated with the entity transmitting the message.

In other words, it has heretofore been difficult to identify the entity transmitting an unauthorized communication message.

On the other hand, if the communication apparatus 20 according to the present embodiment receives an unauthorized communication message, the communication apparatus 20 outputs a notification message 52 including the unauthorized communication identification information and the reception position information. The identifier 60A for identifying the entity can thus identify the entity transmitting the unauthorized communication message by using the notification message 52. In other words, the communication apparatus 20 according to the present embodiment can enable the identification of the entity transmitting the unauthorized communication message by outputting the notification message 52 including the unauthorized communication identification information and the reception position information.

The communication apparatus 20 according to the present embodiment can thus enable the identification of the entity of the unauthorized communication.

The server apparatus 10 according to the present embodiment is a server apparatus 10 which communicates with one or a plurality of communication apparatuses 20, and includes the identifier 60A. The identifier 60A includes the acquirer 60D, the identical identifier 60E, and the entity identifier 60F.

The acquirer 60D obtains a plurality of notification messages 52. The notification messages 52 each include unauthorized communication identification information for identifying an unauthorized communication message received by a communication apparatus 20, and reception position information indicating the position of the communication apparatus 20 when the unauthorized communication message is received by the communication apparatus 20. The identical identifier 60E identifies a plurality of notification messages 52 corresponding to the identical unauthorized communication message. The entity identifier 60F identifies the entity transmitting the unauthorized communication message on the basis of the unauthorized communication identification information and the reception position information included in each of the plurality of notification messages 52 corresponding to the identical unauthorized communication message.

In such a manner, the server apparatus 10 according to the present embodiment receives a plurality of notification messages 52 from one or a plurality of communication apparatuses 20, and by using a plurality of notification messages 52 corresponding to the identical unauthorized communication message, identifies the entity transmitting the unauthorized communication message.

The server apparatus 10 according to the present embodiment can thus enable the identification of the entity of unauthorized communication.

### Second Embodiment

In the foregoing embodiment, the server apparatus 10 is described to include the identifier 60A (see FIG. 8). However, at least one of the plurality of communication apparatuses 20 in the communication system 1 may be configured to include the identifier for identifying the entity.

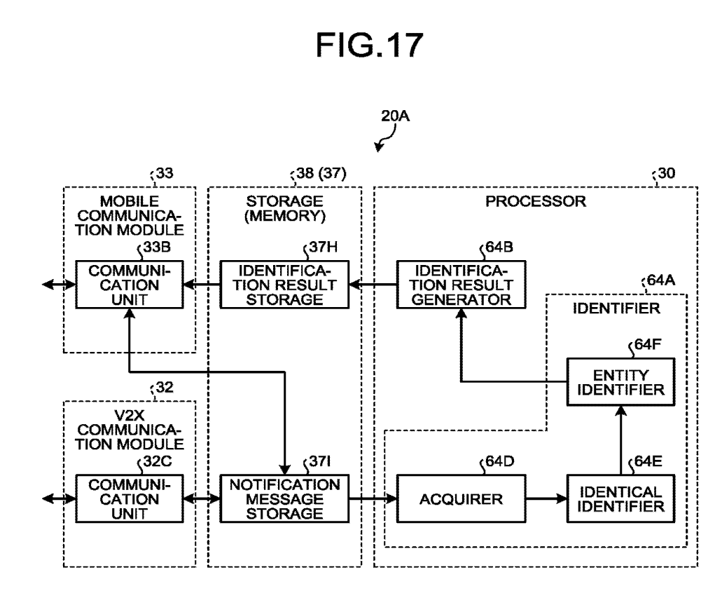

FIG. 17 is an example of a functional block diagram of a communication apparatus 20A. A mobile communication module 33 of the communication apparatus 20A includes a communication unit 33B. The communication unit 33B communicates with the server apparatus 10. A V2X communication module 32 includes a communication unit 32C. The communication unit 32C receives notification messages 52 from the other communication apparatuses 20. The communication unit 32C stores the received notification messages 52 into a notification message storage 37I.

A processor 30 of the communication apparatus 20A includes an identifier 64A and an identification result generator 64B. The identifier 64A includes an acquirer 64D, an identical identifier 64E, and an entity identifier 64F.

The acquirer 64D, the identical identifier 64E, and the entity identifier 64F have functions similar to those of the acquirer 60D, the identical identifier 60E, and the entity identifier 60F described in the foregoing embodiment, respectively (see FIG. 8).

The identifier 64A outputs an identified identification result 70 to the identification result generator 64B. The identification result generator 64B generates an identification result message. The identification result generator 64B stores the identification result message into an identification result storage 37H, and transmits the identification result message to the server apparatus 10 via the communication unit 33B.

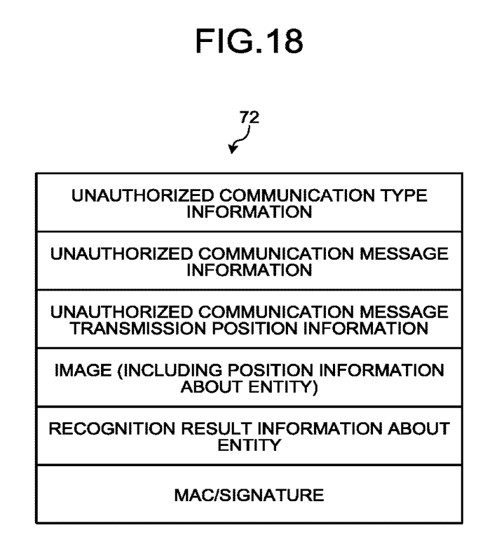

FIG. 18 is a schematic diagram showing an example of a data configuration of the identification result message 72. The identification result message 72 is configured by adding a MAC and signature to the identification result 70 (see FIG. 10).

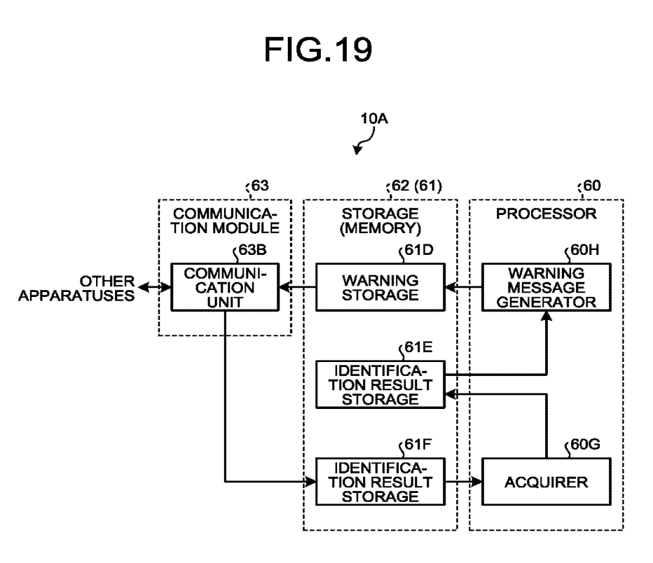

FIG. 19 is an example of a functional block diagram of a server apparatus 10A according to the present embodiment. A communication module 63 of the server apparatus 10A includes a communication unit 63B. The communication unit 63B receives an identification result message 72 from the communication apparatus 20A, and stores the identification result message 72 into an identification result storage 61F. The processor 60 includes a warning message generator 60H and an acquirer 60G. The acquirer 60G obtains the identification result message 72 from the communication apparatus 20A, and stores the identification result message 72 into an identification result storage 61E.

The warning message generator 60H generates a warning message like the warning message generator 60C of the server apparatus 10 (see FIG. 8). The warning message generator 60H stores the warning message into a warning storage 61D, and transmits the warning message to an external apparatus via the communication unit 63B.

As described above, in the present embodiment, the communication apparatus 20A includes the identifier 64A. The present embodiment thus provides the same effects as those of the foregoing first embodiment. In addition, the processing load of the server apparatus 10A and the traffic between the communication apparatus 20A and the server apparatus 10A can be reduced.

Modification

In the foregoing first embodiment, the surrounding situation information 40 included in the notification message 52 is described to include at least any one of the surrounding image 42 and the distance information. However, if the communication apparatus 20 includes a storage having a capacity sufficient to store images, the notification message 52 may be configured to not include at least any one of the surrounding image 42 and the distance information. In such a case, the communication apparatus 20 transmitting the notification message 52 may transmit at least any one of the surrounding image 42 and the distance information to the server apparatus 10 after the position of the entity of the unauthorized communication message is identified on the server apparatus 10 side. This can reduce the traffic between the server apparatus 10 and the communication apparatus 20.

The programs for executing the foregoing processing performed by the communication apparatuses 20 and 20A in the foregoing embodiments may be stored in the storage 38 (see FIG. 2). The programs for executing the foregoing processing performed by the communication apparatuses 20 and 20A in the foregoing embodiments may be provided as preinstalled on the ROM.

Similarly, the programs for executing the foregoing processing performed by the server apparatuses 10 and 10A in the foregoing embodiments may be stored in the storage 62 (see FIG. 3). The programs for executing the foregoing processing performed by the server apparatuses 10 and 10A in the foregoing embodiments may be provided as preinstalled on the ROM.

The programs for executing the foregoing processing performed by the communication apparatuses 20 and 20A and the server apparatuses 10 and 10A in the foregoing embodiments may be stored as files of installable form or executable form in a computer-readable storage medium such as a CD-ROM, a CD-R, a memory card, a DVD (Digital Versatile Disk), and a flexible disk (FD), and provided as a computer program product.

The programs for executing the foregoing processing performed by the communication apparatuses 20 and 20A and the server apparatuses 10 and 10A in the foregoing embodiments may be stored in a computer connected to a network such as the Internet, and provided by downloading via the network. The programs for executing the processing performed by the communication apparatuses 20 and 20A and the server apparatuses 10 and 10A in the foregoing embodiments may be provided or distributed via a network such as the Internet.

For example, the steps of the flow charts in the foregoing embodiments may be changed in execution order, more than one of the steps may be performed at the same time, or the steps may be performed in different order each time without departing from the nature thereof.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication apparatus comprising:
a communication unit configured to receive an unauthorized communication message; and
an output unit configured to output a notification message based on the unauthorized communication message, the notification message including unauthorized communication identification information for identifying the unauthorized communication message and reception position information indicating a position of the communication apparatus when the unauthorized communication message is received, the unauthorized communication identification information including entire frame information about the unauthorized communication message.

2. The apparatus according to claim 1, wherein the output unit outputs the notification message to an identifier configured to identify an entity that transmits the unauthorized communication message based on the unauthorized communication message.

3. The apparatus according to claim 1, wherein the notification message further includes surrounding situation information representing a surrounding situation of the communication apparatus when the unauthorized communication message is received.

4. The apparatus according to claim 1, wherein the unauthorized communication identification information further includes a reception time when the unauthorized communication message is received by the communication apparatus.

5. The apparatus according to claim 1, wherein the notification message further includes at least one of identification information for identifying another communication message received before the unauthorized communication message and identification information for identifying another communication message received after the unauthorized communication message.

6. The apparatus according to claim 2, wherein the output unit outputs the notification message to a server apparatus including the identifier.

7. The apparatus according to claim 1, mounted on a mobile unit.

8. A server apparatus for communicating with one or more communication apparatuses, the apparatus comprising:
an acquirer configured to acquire a plurality of notification messages including unauthorized communication identification information for identifying an unauthorized communication message received by the one or more communication apparatuses and reception position information indicating a position of the one or more communication apparatuses when the unauthorized communication message is received by the one or more communication apparatuses, the unauthorized communication identification information including entire frame information about the unauthorized communication message;
an identical identifier configured to identify a plurality of notification messages corresponding to an identical unauthorized communication message; and
an entity identifier configured to identify an entity that transmits the unauthorized communication message based on the unauthorized communication identification information and the reception position information included in each of the plurality of notification messages corresponding to the identical unauthorized communication message.

9. The apparatus according to claim 8, wherein the entity identifier identifies a position of the entity that transmits the unauthorized communication message based on the unauthorized communication identification information and the reception position information included in each of the plurality of notification messages corresponding to the identical unauthorized communication message.

10. The apparatus according to claim 8, wherein the unauthorized communication identification information further includes a reception time when the unauthorized communication message is received by the one or more communication apparatuses.

11. The server apparatus according to claim 8, wherein
the notification messages include surrounding situation information representing a surrounding situation of the one or more communication apparatuses when the unauthorized communication message is received, and
the entity identifier identifies a position of the entity transmitting the unauthorized communication message and recognition result information representing a recognition result of the entity based on the unauthorized communication identification information, the reception position information, and the surrounding situation information included in each of the plurality of notification messages corresponding to the identical unauthorized communication message.

12. The apparatus according to claim 8, wherein
the notification messages include at least one of identification information for identifying another communication message received before the unauthorized communication message and identification information for identifying another communication message received after the unauthorized communication message, and
the entity identifier identifies the entity that transmits the unauthorized communication message based on the unauthorized communication identification information, the reception position information, and the identification information included in each of the plurality of notification messages corresponding to the identical unauthorized communication message.

13. A communication system comprising:
a communication apparatus; and
a server apparatus configured to communicate with the communication apparatus,
the communication apparatus including
a communication unit configured to receive an unauthorized communication message, and
an output unit configured to output a notification message to the server apparatus based on the unauthorized communication message received by the communication unit, the notification message including unauthorized communication identification information for identifying the unauthorized communication message and reception position information indicating a position of the communication apparatus when the unauthorized communication message is received, the unauthorized communication identification information including entire frame information about the unauthorized communication message, and
the server apparatus including
an acquirer configured to acquire a plurality of notification messages,
an identical identifier configured to identify a plurality of notification messages corresponding to the identical unauthorized communication message, and
an entity determiner configured to identify an entity that transmits the unauthorized communication message based on the unauthorized communication identification information and the reception position information included in each of the plurality of notification messages corresponding to the identical unauthorized communication message.
